(19) United States
(12) Patent Application Publication
(10) Pub. No.: US 2026/0276848 A1
(43) Pub. Date: Sep. 17, 2026

(54) BENDABLE RADIATION DETECTOR FOR MEASURING POSTURE AND POSITION, AND OPERATION METHOD FOR RADIATION DETECTOR

(71) Applicant: DRTECH CORPORATION, Seongnam-si Gyeonggi-do (KR)

(72) Inventors: Beom Jin MOON, Suwon-si Gyeonggi-do (KR); Hyeong Sik KIM, Hwaseong-si Gyeonggi-do (KR); Dae Sung KIM, Seongnam-si Gyeonggi-do (KR)

(73) Assignee: DRTECH CORPORATION, Seongnam-si Gyeonggi-do (KR)

(21) Appl. No.: 19/674,612

(22) Filed: May 12, 2026

Related U.S. Application Data
(63) Continuation of application No. PCT/KR2024/020107, filed on Dec. 9, 2024.

(30) Foreign Application Priority Data
Dec. 11, 2023 (KR) 10-2023-0178378

(51) Int. Cl. G01T 7/00; G01B 7/30; G01D 5/16; G01N 23/046; G01N 23/083

(52) U.S. Cl. CPC G01T 7/00; G01B 7/30; G01D 5/16; G01N 23/046; G01N 23/083; G01N 2223/628

(57) ABSTRACT

A radiation detector for detecting radiation of the present disclosure includes a radiation detection panel, which is flexible, extending in a first direction and detecting radiation incident on a first surface, a bending support unit coupled to the radiation detection panel and supporting the radiation detection panel, and controlling bending based on a bending axis parallel to a second direction of the radiation detection panel, and a posture-position sensor coupled to the bending support unit, for determining at least one of a degree of bending of the radiation detection panel or a position of the radiation detection panel with respect to an object.

### CROSS-REFERENCE TO RELATED APPLICATIONS

This application is a continuation of International Application No. PCT/KR2024/020107 filed on Dec. 9, 2024, which claims priority to and the benefit of Korean Patent Applications No. 10-2023-0178378 filed on Dec. 11, 2023, the disclosures of which are incorporated herein by reference in their entirety.

### FIELD OF THE INVENTION

The present disclosure relates to a bendable radiation detector for measuring a posture and a position and an operating method thereof. More specifically, the bendable radiation detector may measure a position of the radiation detector with respect to an object and a degree of bending.

### BACKGROUND OF THE INVENTION

A bendable radiation detector may be used to inspect the inside of a pipe (object). The pipe may be a pipe having a diameter of about 2 inches or more, and is used as a pipeline for transporting gas or oil, a pipe for carrying water and sewage, or the like. The reason for inspecting such a pipe is to supplement and treat a case where wear or damage occurs at a junction of pipes according to a material transported by each of the pipes. A bendable radiation detector may be required to image the pipe. As the detector becomes larger, it must withstand a large physical force, so for stable operation of the radiation detector, the radiation detector may have a mechanical structure capable of overcoming an applied force.

In a case of the bendable radiation detector, a mechanical structure for maintaining a curvature shape may be required. Unlike a flat panel radiation detector, a bendable radiation detector designed to reduce distortion of a pipe may have a mechanical structure for maintaining curvature and a mechanical structure for preventing excessive curvature from being created.

In order for a bendable radiation detector to inspect an object at an industrial site, it must be able to move around the object. However, since a conventional bendable radiation detector does not measure a position of the bendable radiation detector with respect to an object, there was a possibility that an operator might not image a portion of the surroundings of the object.

### SUMMARY

### Technical Problem

The present disclosure relates to a radiation detector measuring a position of the radiation detector with respect to an object. In addition, the present disclosure relates to a radiation detector measuring a posture of the radiation detector suitable for an object.

### Technical Solution

A radiation detector for detecting radiation according to the present disclosure includes a radiation detection panel, which is flexible, extending in a first direction and detecting radiation incident on a first surface, a bending support unit coupled to the radiation detection panel and supporting the radiation detection panel, and controlling bending based on a bending axis parallel to a second direction of the radiation detection panel, and a posture-position sensor coupled to the bending support unit, for determining at least one of a degree of bending of the radiation detection panel or a position of the radiation detection panel with respect to an object.

A radiation detector according to the present disclosure includes a controller for controlling an operation of the radiation detector, and the controller determines an initial position of the radiation detector with respect to an object based on a posture-position sensor, and when the radiation detector moves from the initial position, acquires a position of a radiation detection panel with respect to the object in real time based on the posture-position sensor.

A radiation detector according to the present disclosure includes a controller for controlling an operation of the radiation detector, and when a second direction is parallel to the ground, the controller determines a position of a radiation detection panel with respect to an object using at least one of an acceleration sensor and a gyro sensor included in a posture-position sensor, and when the second direction is perpendicular to the ground, the controller determines the position of the radiation detection panel with respect to the object using at least one of a geomagnetic sensor and a gyro sensor included in the posture-position sensor.

A radiation detector according to the present disclosure includes a controller for controlling an operation of the radiation detector, and the controller determines a first position included in a position of a radiation detection panel with respect to an object using at least one of an acceleration sensor and a gyro sensor included in a posture-position sensor, and determines a second position included in the position of the radiation detection panel with respect to the object using at least one of a geomagnetic sensor and a gyro sensor included in the posture-position sensor.

A radiation detector according to the present disclosure includes a controller for controlling an operation of the radiation detector, and the controller acquires a degree of bending of a radiation detection panel with respect to a predetermined initial posture based on a posture-position sensor.

A posture-position sensor of a radiation detector according to the present disclosure includes at least one of a potentiometer, a geomagnetic sensor, an acceleration sensor, and a gyro sensor.

A bending support unit of a radiation detector according to the present disclosure includes a central rear cover and a side rear cover rotatable with respect to the central rear cover based on an axis parallel to a second direction, and a potentiometer included in a posture-position sensor outputs a different potentiometer output value as the side rear cover rotates with respect to the central rear cover, and a controller determines a degree of bending of a radiation detection panel based on the potentiometer output value.

A bending support unit of a radiation detector according to the present disclosure includes a central rear cover including a first posture-position sensor included in a posture-position sensor and a side rear cover rotatable with respect to the central rear cover based on an axis parallel to a second direction and including a second posture-position sensor included in the posture-position sensor, and determines at least one of a bending angle of a radiation detection panel or a position of the radiation detection panel with respect to an object based on at least one of a first direction angle measured by the first posture-position sensor and a second direction angle measured by the second posture-position sensor.

A bending support unit of a radiation detector according to the present disclosure includes a central rear cover, a side rear cover rotatable with respect to the central rear cover based on an axis parallel to a second direction, a sliding guide unit coupled to a rear of the side rear cover and including a potentiometer included in a posture-position sensor, and a sliding unit having one side coupled to the central rear cover, another side coupled to the potentiometer, and slidably coupled to the sliding guide unit, and when the bending support unit is bent or unfolded, the sliding unit slides along the sliding guide unit, and when the sliding unit slides along the sliding guide unit, a potentiometer output value of the potentiometer is changed, and a controller determines a degree of bending of a radiation detection panel based on the potentiometer output value.

A bending support unit of a radiation detector according to the present disclosure includes a central rear cover, a side rear cover rotatable with respect to the central rear cover based on an axis parallel to a second direction, a sliding guide unit coupled to a rear of the side rear cover and including a rack gear, and a sliding unit having one side coupled to the central rear cover, another side coupled to a potentiometer included in a posture-position sensor, and slidably coupled to the sliding guide unit, and when the bending support unit is bent or unfolded, the sliding unit slides along the sliding guide unit, and when the sliding unit slides along the sliding guide unit, a potentiometer output value is changed as a pinion gear coupled to the potentiometer rotates by being engaged with the rack gear, and a controller determines a degree of bending of a radiation detection panel based on the potentiometer output value.

A radiation detector according to the present disclosure includes a controller for controlling an operation of the radiation detector, and the controller determines a number of times of bending for each bending degree based on bending information of a radiation detection panel, the number of times of bending indicates a number of times the radiation detection panel is bent and then unfolded again, and the bending degree means a degree to which the radiation detection panel is maximally bent when one time of bending is performed.

A radiation detector according to the present disclosure includes a controller for controlling an operation of the radiation detector, and the controller determines that a force applied to bending is larger as a degree of bending of a radiation detection panel indicates more bending.

A controller of a radiation detector according to the present disclosure determines measured bending information related to a force required to bend a radiation detection panel, determines bending correction information based on a degree of bending of the radiation detection panel, and determines corrected bending information by adding the bending correction information to the measured bending information.

A controller of a radiation detector according to the present disclosure determines bending correction information by multiplying a quotient, obtained by dividing a degree of bending of a radiation detection panel by a predetermined unit variation, by a predetermined bending weight.

A controller of a radiation detector according to the present disclosure acquires first usage information obtained by multiplying corrected bending information corresponding to a first bending degree by a number of times of bending corresponding to the first bending degree, acquires second usage information obtained by multiplying corrected bending information corresponding to a second bending degree by a number of times of bending corresponding to the second bending degree, acquires total usage information obtained by adding the first usage information and the second usage information, and when the total usage information is larger than predetermined lifespan information, outputs a message for performing a check on the detector.

A controller of a radiation detector according to the present disclosure acquires total usage information obtained by adding all numbers of times of bending corresponding to a bending degree, and when the total usage information is larger than predetermined lifespan information, outputs a message for performing a check on the detector.

A radiation detector according to the present disclosure includes a controller for controlling an operation of the radiation detector, and the controller determines whether or not to be in a power saving mode based on a degree of bending of a radiation detection panel.

A radiation detector according to the present disclosure includes a controller for controlling an operation of the radiation detector, and the controller determines correction data based on a degree of bending of a radiation detection panel, and the correction data is data for correcting at least one of a magnitude of radiation and a reception direction of radiation received by a pixel of the radiation detection panel according to the degree of bending of the radiation detection panel.

A radiation detector according to the present disclosure includes a controller for controlling an operation of the radiation detector, and the controller determines whether or not an impact unintended by user has been applied based on a sensor value of a posture-position sensor.

In addition, a program for implementing an operating method of a radiation detector of the present disclosure may be recorded in a computer-readable recording medium.

### Advantageous Effects

In addition, a radiation detector of the present disclosure may measure a posture when imaging an object, and may measure a pipe caliber (diameter) based on the posture. Since correction for an imaged image may be performed according to the pipe caliber, the radiation detector of the present disclosure may acquire a uniform and clear image regardless of a size of an object.

In addition, the radiation detector of the present disclosure may identify a number of times of bending, and may estimate a lifespan based on the number of times of bending. Accordingly, since a user may prepare a spare radiation detector in advance before a problem occurs in the radiation detector, a situation in which the radiation detector suddenly does not operate at a site may be prevented.

In addition, since the radiation detector of the present disclosure may identify a position of the radiation detector with respect to an object in real time, a portion of the object for which an inspection is not performed may be minimized. In addition, since a radiation detector 100 of the present disclosure may accurately perform an inspection on a position of the radiation detector with respect to an object 130 on an inspection plan, an inspection time of the object 130 may be significantly reduced.

Here, the inspection plan may include an inspection position for the object. In addition, when there is an object 130 requiring an additional inspection, an entire inspection is not performed and the inspection may be performed only at a position requiring an inspection, so that the inspection time may be significantly reduced.

The radiation detector of the present disclosure may measure a magnitude of an external impact and store it in log data. A user may check log data of the radiation detector to inspect in advance the radiation detector to which an excessively large external force is applied.

Accordingly, the radiation detector may always maintain an optimal state for inspection.

In addition, the radiation detector of the present disclosure may be in a power saving mode or an imaging mode according to a change in posture. Since a process in which a user presses a power button of the radiation detector to inspect an object is reduced, convenience of the user may be increased.

However, effects of the radiation detector of the present disclosure are not limited to the effects described above.

### DESCRIPTION OF DRAWINGS

FIG. 1 is a perspective view showing a radiation detector according to an embodiment of the present disclosure.

FIG. 2 is a view showing use of a radiation detector according to an embodiment of the present disclosure.

FIG. 3 is a view for explaining a radiation detector according to an embodiment of the present disclosure.

FIG. 4 is a view for explaining a controller according to an embodiment of the present disclosure.

FIG. 5 is a view for explaining a radiation detector according to an embodiment of the present disclosure.

FIGS. 6A, 6B, 6C, and 6D are views for explaining an operation of a radiation detector according to an embodiment of the present disclosure.

FIGS. 7A and 7B are views for explaining a degree of bending of a radiation detector according to an embodiment of the present disclosure.

FIGS. 8A, 8B, 8C, and 8D are views for explaining a position of a posture-position sensor according to an embodiment of the present disclosure.

FIG. 9 is a view for explaining a method for determining an angle of a radiation detector according to an embodiment of the present disclosure.

FIGS. 10A and 10B may be a view for explaining a radiation detector according to an embodiment of the present disclosure.

FIG. 11 may be a view for explaining a radiation detector according to an embodiment of the present disclosure.

FIG. 12 may be a view for explaining a radiation detector according to an embodiment of the present disclosure.

FIG. 13 may be a view for explaining a radiation detector according to an embodiment of the present disclosure.

FIG. 14 may be a view for explaining a radiation detector according to an embodiment of the present disclosure.

FIG. 15 is a view for explaining an operation of a radiation detector according to an embodiment of the present disclosure.

FIG. 16 is a flowchart showing an operating method of a radiation detector according to an embodiment of the present disclosure.

FIG. 17 is a flowchart showing an operating method of a radiation detector according to an embodiment of the present disclosure.

FIG. 18 is a flowchart showing an operating method of a radiation detector according to an embodiment of the present disclosure.

FIG. 19 is a view for explaining an operating method of a radiation detector according to an embodiment of the present disclosure.

### DETAILED DESCRIPTION

Advantages and features of the disclosed embodiments, and methods for achieving them, will become clear with reference to the embodiments described below in conjunction with the accompanying drawings. However, the present disclosure is not limited to the embodiments disclosed below but may be implemented in various different forms, and these embodiments are merely provided to make the present disclosure complete and to completely inform those of ordinary skill in the art to which the present disclosure pertains of the scope of the invention.

Terms used in the present specification will be briefly described, and the disclosed embodiments will be described in detail.

For the terms used in the present specification, general terms that are currently widely used as much as possible were selected while considering functions in the present disclosure, but this may vary according to intentions of technicians engaged in the related field, precedents, emergence of new technologies, or the like. In addition, in specific cases, there are terms arbitrarily selected by the applicant, and in this case, the meaning thereof will be described in detail in the description part of the corresponding invention. Therefore, a term used in the present disclosure should be defined based on the meaning of the term and the overall contents of the present disclosure, rather than a simple name of the term.

Expressions in the singular in the present specification include expressions in the plural unless the context clearly specifies otherwise as being singular. In addition, expressions in the plural include expressions in the singular unless the context clearly specifies otherwise as being plural.

When it is stated that a certain part “comprises” a certain component throughout the specification, this means that other components are not excluded but may be further included, unless specifically stated otherwise.

In addition, the term “unit” used in the specification means a software or hardware component, and the “unit” performs certain roles. However, the “unit” is not limited in meaning to software or hardware. The “unit” may be configured to be in an addressable storage medium or may be configured to reproduce one or more processors. Thus, as an example, the “unit” includes components such as software components, object-oriented software components, class components, and task components, and processes, functions, attributes, procedures, subroutines, segments of program code, drivers, firmware, microcode, circuits, data, databases, data structures, tables, arrays, and variables. Functions provided in components and “units” may be combined into a smaller number of components and “units” or may be further separated into additional components and “units”.

According to an embodiment of the present disclosure, the “unit” may be implemented as a processor and a memory. The term “processor” should be interpreted broadly to include general-purpose processors, central processing units (CPUs), microprocessors, digital signal processors (DSPs), controllers, microcontrollers, state machines, and the like. In some environments, the “processor” may refer to application-specific integrated circuits (ASICs), programmable logic devices (PLDs), field-programmable gate arrays (FPGAs), or the like. The term “processor” may refer to a combination of processing devices such as, for example, a combination of a DSP and a microprocessor, a combination of a plurality of microprocessors, a combination of one or more microprocessors combined with a DSP core, or any other combination of such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, and the like. If a processor can read information from and/or write information to a memory, the memory is said to be in electronic communication with the processor. A memory integrated into a processor is in electronic communication with the processor.

Hereinafter, embodiments will be described in detail with reference to the accompanying drawings so that those of ordinary skill in the art to which the present disclosure pertains can easily practice the same. In addition, in order to clearly describe the present disclosure in the drawings, parts irrelevant to the description are omitted.

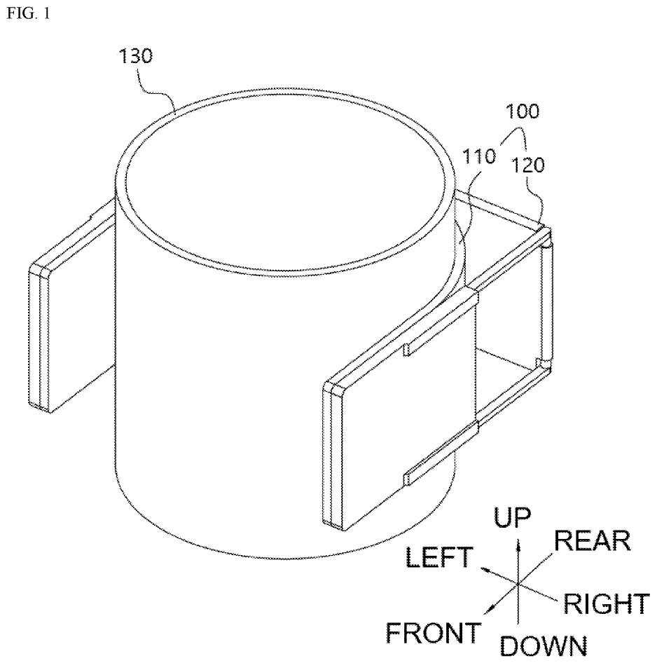

FIG. 1 is a perspective view showing a radiation detector according to an embodiment of the present disclosure.

The radiation detector 100 of the present disclosure may be a device detecting radiation emitted from a radiation source and transmitted through an object. Radiation may include at least one of X-rays, gamma rays, and some ultraviolet rays. The radiation detector 100 may acquire a radiation image of an object by detecting radiation. For example, a radiation image acquired by the radiation detector 100 may include at least one of an X-ray image and a computed tomography (CT) image.

FIG. 1 shows a state in which the radiation detector 100 of the present disclosure is bent according to a shape of the object 130. The radiation detector 100 may include a radiation detection panel 110. The radiation detection panel 110 may extend in a first direction. The first direction may be a left direction. However, it is not limited thereto and may be a right direction. That is, the radiation detection panel 110 may extend in a left-right direction. It should be noted that the first direction is not a direction fixed with respect to the ground. According to a direction in which the radiation detector 100 is placed with respect to the ground, the first direction may face a different direction with respect to the ground. For example, when a surface of the radiation detector 100 is parallel to the ground, the first direction may be a direction parallel to the ground. When the surface of the radiation detector 100 is perpendicular to the ground, the first direction may be a direction perpendicular to the ground.

The radiation detection panel 110 may detect radiation incident on a first surface. Here, the first surface may mean a front surface (front side surface) of the radiation detection panel 110. A panel protection unit for protecting the front surface of the radiation detection panel 110 may be positioned on the front surface of the radiation detection panel 110. That is, the radiation detection panel 110 includes a panel protection unit, and a light receiving element included in the radiation detection panel 110 may not be exposed to the outside. The radiation detection panel 110 may be protected from external impact by the panel protection unit.

The radiation detection panel 110 may be flexible. The radiation detection panel included in the radiation detection panel 110 may be bendable because it has flexibility. When a surface of an object has a round surface, the radiation detection panel 110 may be bent and brought into close contact with the surface of the object. Since the radiation detection panel 110 is positioned in close contact with the surface of the object, sharpness of a radiation image may be increased. A radiation image may be clearer as a distance between a radiation detector and an outer peripheral surface of an object is closer, but when a round object is imaged with a radiation detector that is not bent, a distance between the radiation detector and the object is not constant, so that distortion may occur in the radiation image. The radiation detector 100 of the present disclosure is bendable, so it can acquire a clear radiation image. However, being bendable is not enough and a structure in which the radiation detector 100 can be fixed close to an object is required, and a fixing structure will be described later.

The radiation detection panel 110 may be divided into an indirect conversion type obtaining an indirect electrical signal by visible light using a scintillator and a direct conversion type obtaining a direct electrical signal from radiation using photoconductors according to an acquisition method of an electrical signal, and may be classified into a CCD method using a charge-coupled device, a CMOS method using a CMOS device of crystalline silicon, and an a-Si method using an amorphous silicon thin film transistor (TFT) substrate according to a type of device generating an electrical signal. The TFT panel of the present disclosure may be replaced by various methods for sensing visible light or radiation other than the TFT method.

The radiation detection panel 110 may implement digital image data with an electrical signal and position information of a sensor proportional to an incident amount of radiation by being provided with various sensors. The radiation detection panel 110 can obtain an imaging result close to real time and can secure a high resolution and a wide dynamic range with relatively little radiation, and storage and processing of the imaging result are simple due to characteristics of digital data. The radiation detection panel 110 includes a readout signal unit reading an electrical signal output from a pixel array, a gate driver for turning on a switching element so that the readout signal unit can read an electrical signal, and the like, and an electrical signal detected by the readout signal unit is converted into an image signal through a certain processing process in a controller or the like provided on a main board and then transmitted to a display device for displaying an X-ray image.

The radiation detection panel 110 may include a configuration such as at least one of a pixel array, a readout signal unit, a gate driver circuit unit, and a main board. The readout signal unit is implemented with a plurality of readout ICs (ROICs) in a film form, and each ROIC may be coupled to a main board (a first circuit unit or a second circuit unit) by a connector.

The radiation detection panel 110 may include a light receiving element detecting radiation to generate an electrical signal and a readout circuit unit reading out the generated electrical signal. After processing an electrical signal output from the readout circuit unit, the controller may generate X-ray image data constituting an X-ray image. The generated X-ray image data may be stored in a storage unit together with (or separately from) detector state information or information related to X-ray imaging.

In order to sequentially perform operations of detecting X-ray information in the radiation detection panel 110 and delivering the same to an external computer, the radiation detection panel 110 may use a power and data cable delivering both power (or power source) supply and data communication.

In addition, the radiation detection panel 110 may use WiFi and Gigabit Ethernet for wired/wireless data transmission. In addition, the controller of the radiation detection panel 110 may be coupled to communicate with a workstation for variables for driving an image sensor and the like.

The radiation detector 100 may include a bending support unit 120. The bending support unit 120 may be coupled to the radiation detection panel 110. The bending support unit 120 may be in contact with a second surface facing the first surface of the radiation detection panel 110. The second surface may be a surface opposite to the first surface. The first surface may mean a front surface of the radiation detection panel 110. The second surface may mean a rear surface of the radiation detection panel 110. Here, for convenience of explanation, it is described that the bending support unit 120 is in contact with the rear surface of the radiation detection panel 110, but it is not limited thereto. The bending support unit 120 may be in contact with at least one of a rear surface, a left side surface, a right side surface, a lower surface, and an upper surface of the radiation detection panel 110. At least a part of the front surface of the radiation detection panel 110 may also be in contact with the bending support unit 120. Here, being in contact means one of point contact, line contact, and surface contact.

The bending support unit 120 may support the radiation detection panel 110. The bending support unit 120 may protect the radiation detection panel 110. Since the radiation detection panel 110 is flexible and thus bendable, it may be difficult to keep the radiation detection panel 110 still with respect to the object if there is no bending support unit 120. This is because the radiation detection panel 110 will be easily deformed by movement of the object or external force. Accordingly, the bending support unit 120 may be a configuration for supporting the radiation detection panel 110 to maintain a constant shape after being bent. In addition, the bending support unit 120 may prevent the radiation detection panel 110 from being excessively bent or may prevent damage from external impact.

The bending support unit 120 is coupled to the radiation detection panel 110 and may support the radiation detection panel 110. The bending support unit 120 may control bending based on a bending axis parallel to a second direction of the radiation detection panel 110. The bending support unit 120 may control bending of the radiation detection panel 110 around a bending axis parallel to a second direction crossing the first direction. The first direction and the second direction may be orthogonal to each other. The first direction may mean the left. In addition, the second direction may mean an upper side of the radiation detector 100. However, it is not limited thereto and the second direction may be a downward direction of the radiation detector 100. The bending support unit 120 may control bending of the radiation detection panel 110 around at least one bending axis parallel to an up-down direction. The radiation detection panel 110 may also be bent as much as the bending support unit 120 is bent. In addition, the bending support unit 120 may help the radiation detection panel 110 maintain a bent shape. When the object 130 is a pipe, an extension direction of the object 130 may coincide with the second direction.

In the present disclosure, the first direction and the second direction may be directions based on the radiation detector 100. It should be noted that the first direction and the second direction are not directions fixed with respect to the ground. According to a direction in which the radiation detector 100 is placed with respect to the ground, the first direction and the second direction may face different directions with respect to the ground. For example, when a surface of the radiation detector 100 is parallel to the ground, the second direction may be a direction parallel to the ground. When the surface of the radiation detector 100 is perpendicular to the ground, the second direction may be a direction perpendicular to the ground.

The bending support unit 120 may include various configurations for operation of the radiation detector 100. For example, the bending support unit 120 may include at least one of a controller, a communication unit, an input unit, and an output unit for operation of the radiation detector 100. However, it is not limited thereto, and the radiation detection panel 110 may include at least one of a controller, a communication unit, an input unit, and an output unit.

In addition, the radiation detection panel 110 may be embedded in the bending support unit 120. However, it is not limited thereto, and the bending support unit 120 and the radiation detection panel 110 may be independent configurations.

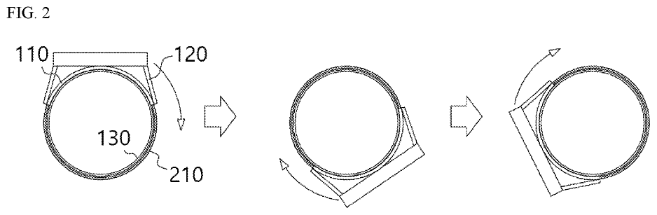

FIG. 2 is a view showing use of a radiation detector according to an embodiment of the present disclosure.

Referring to FIG. 2, the radiation detector 100 for detecting radiation may image while rotating around the object 130. The object 130 may be an object having a curved surface, or a spherical or cylindrical object. For example, the object 130 may be a pipe. However, it is not limited thereto, and the object 130 may be an object having a flat surface.

The radiation detector 100 may image a radiation image while moving around an outer peripheral surface of the object 130 in order to detect a crack in the pipe. Although not shown in FIG. 2, a source assembly for radiating radiation may be positioned on an opposite side to the radiation detector 100.

Since the radiation detector 100 images a radiation image close to the object 130, the radiation detection panel 110 of the radiation detector 100 may be damaged by the object 130. However, the radiation detector 100 of the present disclosure may include a front protection unit for protecting the radiation detector 100. Since the radiation detection panel 110 is not damaged by the front protection unit, performance of the radiation detector 100 can be maintained for a long period of time.

The radiation detector 100 may include a radiation detection panel 110, which is flexible, extending in a first direction and detecting radiation incident on a first surface. The radiation detection panel 110 may be bent according to a shape of the object 130. Since the radiation detection panel 110 has already been described, redundant description is omitted.

The radiation detector 100 may include a bending support unit 120 being in contact with a second surface facing the first surface of the radiation detection panel 110, supporting the radiation detection panel 110, and controlling bending of the radiation detection panel 110 around a bending axis parallel to a second direction crossing the first direction.

A fixing band 210 may be used in order for the radiation detector 100 to be fixed to the object 130. The fixing band 210 may be directly coupled to at least one of the radiation detection panel 110 and the bending support unit 120. However, it is not limited thereto and the fixing band 210 may be fixed to a detector fixing assembly coupled to at least one of the radiation detection panel 110 and the bending support unit 120. Since there are cases where the fixing band 210 is not required according to a site, the detector fixing assembly may be implemented to be detachable for weight reduction and miniaturization of the radiation detector 100. However, it is not limited thereto.

The detector fixing assembly may allow the radiation detector 100 to maintain a predetermined distance from the object 130 having an outer surface of a flat surface or a curved surface. Here, the predetermined distance may be 0 mm or more and 10 mm or less. However, it is not limited thereto. At least a part of the radiation detection panel 110 of the radiation detector 100 may also come into contact with the object 130. The predetermined distance between the radiation detector 100 and the object 130 may be 0 mm or more and 50 mm or less.

The radiation detector 100 may include a detector fixing assembly. The detector fixing assembly is detachably coupled to the bending support unit 120 and may include a roller being in contact with the fixing band 210 for coupling the radiation detector 100 and the object 130 or being in contact with the object 130. The fixing band 210 may surround at least a part of the object 130. The radiation detector 100 and the fixing band 210 may surround the entirety of the object 130.

Hereinafter, a radiation detector 100 capable of position measurement and posture measurement of the present disclosure will be described in more detail.

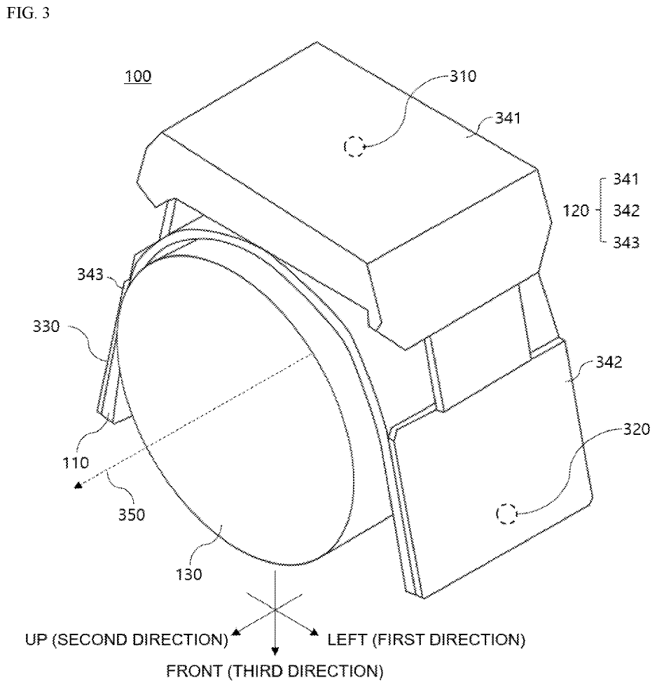

FIG. 3 is a view for explaining a radiation detector according to an embodiment of the present disclosure.

As already described, the radiation detector 100 may include a radiation detection panel 110 and a bending support unit 120. Since the radiation detection panel 110 and the bending support unit 120 have already been described, redundant description is omitted.

The radiation detector 100 may include a posture-position sensor. The posture-position sensor may be coupled to the bending support unit 120. The posture-position sensor may be included inside the bending support unit 120 or may be coupled to the outside of the bending support unit 120.

The posture-position sensor may be a sensor for determining at least one of a degree of bending of the radiation detection panel 110 or a position of the radiation detection panel 110 with respect to the object 130. A degree of bending of the radiation detection panel 110 may have the same meaning as a degree of bending of the radiation detector 100. A degree of bending of the radiation detection panel 110 may be represented by an angle. However, it is not limited thereto.

The bending support unit 120 may include a central rear cover 341 and a side rear cover 342 or 343. The central rear cover 341 may include a first posture-position sensor included in the posture-position sensor. In addition, the side rear cover 342 or 343 may be rotatable with respect to the central rear cover 341 based on an axis parallel to the second direction. The side rear cover 342 or 343 may include a second posture-position sensor included in the posture-position sensor.

According to various embodiments of the present disclosure, a left side rear cover 342 may include a second posture-position sensor included in the posture-position sensor, and a right side rear cover 343 may include a third posture-position sensor included in the posture-position sensor. The posture-position sensor may be positioned at at least one of a first sensor position 310, a second sensor position 320, and a third sensor position 330. The first sensor position 310 may be positioned on the central rear cover 341 included in the bending support unit 120. The central rear cover 341 may be a cover positioned at a center in a left-right direction in the bending support unit 120. The second sensor position 320 may be included in a left side rear cover 342 included in the bending support unit 120. The third sensor position 330 may be included in a right side rear cover 343 included in the bending support unit 120. The central rear cover 341 may be positioned between the left side rear cover 342 and the right side rear cover 343. At least one of the left side rear cover 342 and the right side rear cover 343 may be referred to as a side rear cover. However, it is not limited thereto.

The posture-position sensor may include an inertial sensor. The inertial sensor may include at least one of a geomagnetic sensor, an acceleration sensor, and a gyro sensor. The inertial sensor may include a geomagnetic sensor, an acceleration sensor, and a gyro sensor. In addition, the posture-position sensor may include at least one of a potentiometer, a geomagnetic sensor, an acceleration sensor, and a gyro sensor. The posture-position sensor may output a three-dimensional sensor value. However, it is not limited thereto.

The posture-position sensor may include at least one of a posture sensor and a position sensor. The posture sensor and the position sensor may be the same sensor or may be independent sensors. The posture sensor and the position sensor may be positioned at the same position or may be positioned at different positions. In addition, a first group among a plurality of sensor units 510 included in the radiation detector 100 may function as a posture sensor, and a second group may function as a position sensor. The first group and the second group may include overlapping sensor units. However, it is not limited thereto, and the first group and the second group may not include overlapping sensor units.

In addition, since the radiation detection panel 110 will be in close contact with an outer peripheral surface of the object 130 during imaging, a diameter of the object 130 may be determined based on a degree of bending of the radiation detection panel 110. For example, as the radiation detection panel 110 is bent more, a diameter of the object 130 is smaller, and as the radiation detection panel 110 is bent less, a diameter of the object 130 may be larger. The radiation detector 100 may determine a diameter of an object 130 corresponding to a degree of bending of a radiation detection panel 110 based on a predetermined function or a diameter determination table.

The radiation detector 100 may determine a diameter of an object 130 and cause it to be output from an output unit 540. An output unit 540 of the present disclosure may be an output unit 540 included in the radiation detector 100, or may be an output unit included in an external user terminal. A user terminal may include a laptop, a smartphone, a PC, or the like. A user may compare a diameter of an object 130 on an inspection plan with a measured diameter. Accordingly, an object 130 may be identified. Therefore, a mistake of a user inspecting a different object 130 can be reduced. In addition, it can be confirmed whether an object 130 is properly constructed. In addition, it can also be detected whether a diameter has changed due to impact such as an earthquake applied to an object 130. As such, the radiation detector 100 can inspect an object 130 from various aspects, so an inspection of the object 130 can be performed quickly and faithfully.

In addition, a position of the radiation detection panel 110 with respect to the object 130 may mean a position of the radiation detector 100 with respect to the object 130. The radiation detector 100 may determine where the radiation detector 100 is positioned among 360-degree directions of the object 130 based on initial positions of the radiation detector 100 and the object 130. For example, the object 130 may be a pipe. In this case, the radiation detector 100 may determine where the radiation detector 100 is among 360-degree directions of an object 130 with a rotation axis 350 in an extension direction of the pipe (object) as a center. However, it is not limited thereto, and the radiation detector 100 may determine where it is positioned in three dimensions (up, down, left, right, front, back) with respect to the object 130.

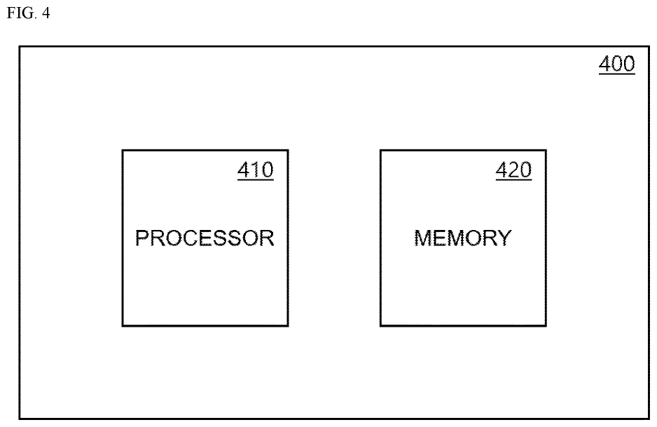

FIG. 4 is a view for explaining a controller according to an embodiment of the present disclosure.

The radiation detector 100 may include a controller 400. The controller 400 may include a processor 410 and a memory 420. The controller 400 may include a processor 410. The processor 410 may be implemented only with hardware for performing functions of the radiation detector 100. However, it is not limited thereto, and the processor 410 may be implemented as a general-purpose processor and perform instructions stored in the memory 420. The controller 400 may include a memory 420. The memory 420 may store instructions executed in the processor 410, or may store information measured from a sensor, preset information, and the like.

In the present disclosure, description is focused on an operation of a radiation detector 100. It should be noted that in the present disclosure, an operation performed by a radiation detector 100 may be performed by a user terminal or a server communicating with the radiation detector 100.

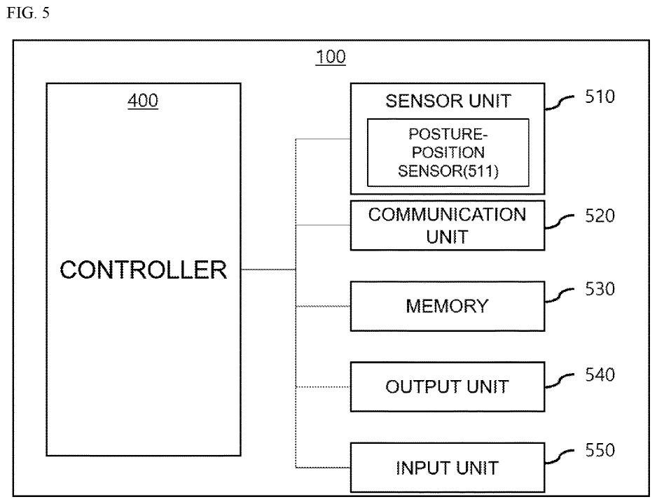

FIG. 5 is a view for explaining a radiation detector according to an embodiment of the present disclosure.

The radiation detector 100 may include a controller 400. The controller 400 may control an operation of the radiation detector 100. The controller 400 may be protected by being included inside at least one of the radiation detection panel 110 or the bending support unit 120. The controller 400 may be included in a control board inside at least one of the radiation detection panel 110 or the bending support unit 120. A control board may be implemented as at least one of a microprocessor on which various configurations are mounted, or a PCB. The controller 400 is protected by a radiation shielding housing, so that malfunction of the controller 400 due to radiation can be prevented.

The radiation detector 100 may include at least one of a sensor unit 510, a communication unit 520, a memory 530, an output unit 540, and an input unit 550, as well as the controller 400.

More specifically, the radiation detector 100 may include a sensor unit 510. The sensor unit 510 may acquire various information using at least one sensor. For example, the sensor unit 510 may include a posture-position sensor 511. A posture-position sensor 511 may include at least one of a potentiometer, a geomagnetic sensor, an acceleration sensor, and a gyro sensor.

In addition, the sensor unit 510 may include a pressure sensor, an infrared sensor, an LED sensor, a touch sensor, or the like. However, it is not limited thereto. A sensor unit 510 may be included in at least one of a radiation detection panel 110, a bending support unit 120, and a control board.

In addition, the radiation detector 100 may include a communication unit 520. The communication unit 520 may be a configuration for the radiation detector 100 to communicate with an internal module or an external device by wire or wireless. An external device may include an external server and a user terminal. A user terminal may include a PC, a smartphone, a tablet, or a wearable device. The communication unit 520 may include a wired/wireless communication module for network connection. As wireless communication technology, for example, wireless LAN (WLAN) (Wi-Fi), wireless broadband (Wibro), world interoperability for microwave access (Wimax), high speed downlink packet access (HSDPA), or the like may be used. As wired communication technology, for example, digital subscriber line (XDSL), fiber to the home (FTTH), power line communication (PLC), or the like may be used. In addition, a network coupling part may include a short-range communication module to transmit and receive data to and from any device/terminal positioned at a short distance. For example, as short range communication technology, Bluetooth, radio frequency identification (RFID), infrared data association (IrDA), ultra-wideband (UWB), ZigBee, or the like may be used, and it is not limited thereto.

The radiation detector 100 may include a memory 530. The memory 530 may correspond to the memory 420. The controller 400 may perform instructions stored in the memory 530. The memory 530 may be included in the controller 400 or may be outside the controller 400. The memory 530 may store various information related to the radiation detector 100.

The memory 530 may be implemented through a non-volatile storage medium capable of continuously storing arbitrary data. For example, the memory 530 may include a storage device based on flash memory and/or battery-backup memory as well as a disk, an optical disk, and a magneto-optical storage device, and is not limited thereto. The memory 530 may mean a volatile storage device such as random access memory (RAM), such as dynamic random access memory (DRAM) and static random access memory (SRAM), as a main storage device directly accessed by a processor, from which stored information is instantly erased when power is turned off, but is not limited thereto. Such a memory 530 may be operated by the controller 400. In addition, the controller 400 may perform instructions included in the memory 530.

In addition, the radiation detector 100 may further include an input-output unit providing an interface for manipulation of the radiation detector 100. An input-output unit may include an output unit 540 and an input unit 550.

The output unit 540 may output sound and an image by which a state of the radiation detector 100 can be checked. The output unit 540 may include a speaker or a display unit. The output unit 540 may output at least one of a count rate, a radiation dose, and a radiation dose rate. The output unit 540 may output an alarm for informing an operator of danger. Examples of the output unit 540 may include a speaker, a printer, a CRT display, an LCD display, a PDP display, an OLED display, an FED display, an LED display, a VFD display, a DLP display, an FPD display, a 3D display, a transparent display, or the like, and may include various output devices within a range obvious to those skilled in the art.

The output unit 540 may be a configuration included in the radiation detector 100, or may be a configuration included in a user terminal. The radiation detector 100 may transmit information to a user terminal through a communication unit 520, and the user terminal may output the same. A user terminal may include a laptop, a PC, a smartphone, a tablet, or the like.

The input unit 550 may receive a command for manipulation of the radiation detector 100 and various information required for radiation measurement from an operator. The input unit 550 may include buttons displayed on a display unit and physical buttons. The controller 400 may control or manipulate the radiation detector 100 based on information input to the input unit 550. The input unit 550 may include a joystick, a keyboard, a mouse, a touch display, buttons, an unlocking button, a voice recognizer, a fingerprint recognizer, an iris recognizer, a human motion recognizer, or the like, and may include an input device obvious to those skilled in the art.

Referring to FIGS. 2 to 5 together, the radiation detector 100 may include a controller 400 for controlling an operation of the radiation detector 100. The controller 400 may perform a step of determining an initial position of the radiation detector with respect to an object based on a posture-position sensor 511. An initial position may be a position at a point in time when the radiation detector 100 is bent to fit an outer peripheral surface of an object and comes into contact with the outer peripheral surface of the object. A user may input a signal for determining an initial position through the input unit 550. Accordingly, the radiation detector 100 may determine an initial position based on the posture-position sensor 511.

In addition, when the radiation detector 100 moves from an initial position, the controller 400 may perform a step of acquiring a position of a radiation detection panel 110 with respect to the object 130 in real time based on the posture-position sensor 511. More specifically, when the radiation detector 100 rotates around a rotation axis 350 parallel to a second direction positioned inside the object 130, the controller 400 may perform a step of acquiring a position of the radiation detection panel 110 with respect to the object 130 in real time. In addition, the controller 400 may accumulate and store real-time positions of the radiation detection panel 110. Accordingly, the radiation detector 100 can detect a portion of the object 130 that is not imaged, and when there is a portion that is not imaged, it can inform a user of the same. Therefore, a user can inspect the object 130 without any missing spots. In addition, a user may not overlap and inspect the same spot. In addition, since radiation can be dangerous to a user, after mounting the radiation detector 100 on the object 130, a user may move to a safe zone and proceed with imaging. At this time, the radiation detector 100 may move with respect to the object 130 by receiving a force from the outside. Since the radiation detector 100 of the present disclosure acquires and outputs a position of the radiation detection panel 110 in real time, even if the radiation detector 100 moves, it can be immediately noticed. In addition, when imaging is performed while the radiation detector 100 automatically rotates with respect to the object 130, the radiation detector 100 can confirm whether the radiation detector 100 is rotating based on the object 130 as planned. Therefore, a radiation detector of the present disclosure can help in quick and accurate inspection of the object 130.

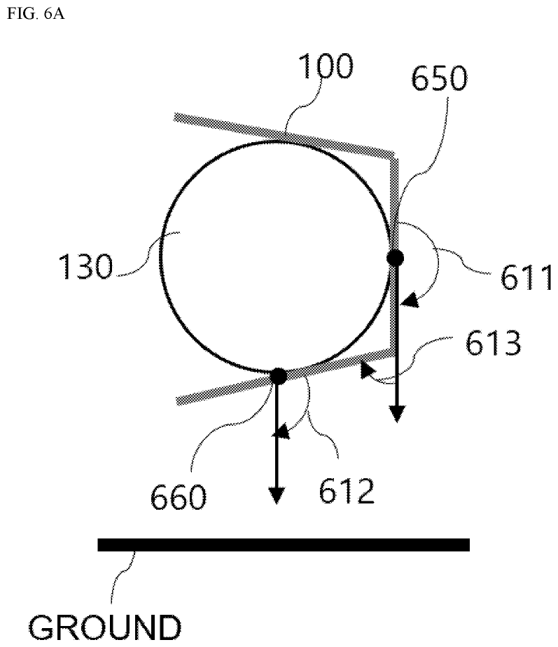

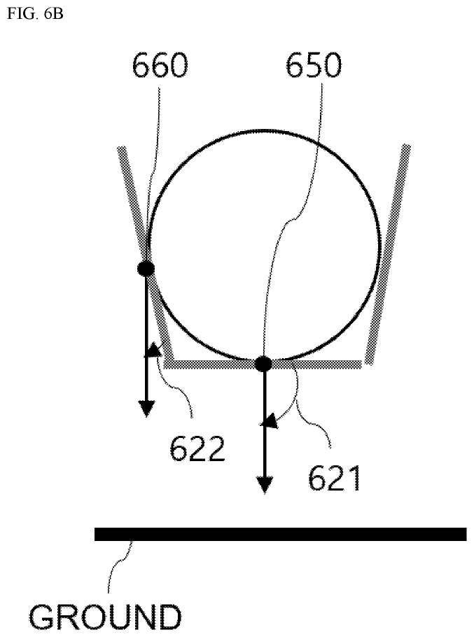

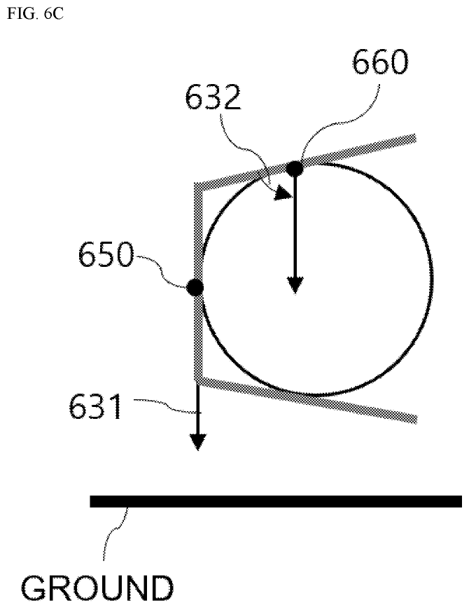

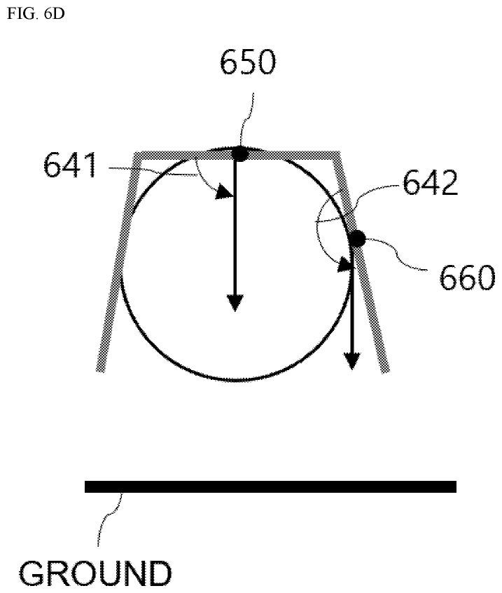

FIGS. 6A, 6B, 6C, and 6D are views for explaining an operation of a radiation detector according to an embodiment of the present disclosure.

At least one of a bending angle of a radiation detection panel or a position of a radiation detection panel with respect to an object may be determined based on at least one of a first direction angle measured by a first posture-position sensor 650 and a second direction angle measured by a second posture-position sensor 660.

For example, when a first direction angle and a second direction angle are changed in the same direction at the same magnitude at the same time, a controller 400 may determine that a position of a radiation detector 100 with respect to an object 130 is changed. The controller 400 may determine a position of the radiation detector 100 with respect to the object 130 based on a predetermined position determination algorithm.

In addition, for example, when a first direction angle and a second direction angle have different magnitudes or have different directions, the controller 400 may determine that a degree of bending of the radiation detector 100 is changed. The controller 400 may determine a degree of bending of the radiation detector 100 based on a predetermined degree of bending determination algorithm.

The radiation detector 100 may include a controller 400 for controlling an operation of the radiation detector 100. When a second direction 350 is parallel to the ground, the controller 400 may perform a step of determining a position of a radiation detection panel with respect to an object using at least one of an acceleration sensor and a gyro sensor included in a posture-position sensor.

An acceleration sensor may be a sensor measuring acceleration applied to the radiation detector 100. An acceleration sensor may measure a magnitude and a direction of gravity applied to the radiation detector 100. Referring to FIG. 6A, a first posture-position sensor 650 may measure a direction of gravity with respect to a first reference direction as a first direction angle 611. Here, a first reference direction may be an extension direction of the radiation detector 100. Since the first posture-position sensor 650 is positioned on a central rear cover 341, a first reference direction may be an extension direction of the central rear cover 341. However, it is not limited thereto and a first reference direction may be a direction perpendicular to the central rear cover 341. A first direction angle 611 may mean a value measured by the first posture-position sensor 650.

In addition, a second posture-position sensor 660 may measure a direction of gravity with respect to a second reference direction as a second direction angle 612. Here, a second reference direction may be an extension direction of the radiation detector 100. Since the second posture-position sensor 660 is positioned on a side rear cover 342 or 343, a reference direction may be an extension direction of the side rear cover 342 or 343. However, it is not limited thereto and a second reference direction may be a direction perpendicular to the side rear cover 342 or 343. A second direction angle 612 may mean a value measured by the second posture-position sensor 660.

The controller 400 may determine a position of the radiation detector 100 with respect to the object 130 based on at least one of a first direction angle 611 and a second direction angle 612. For example, since a first direction angle 611 is 180 degrees, the controller 400 may determine that the radiation detector 100 is positioned at a right side with the object 130 as a center. For reference, in FIGS. 6A, 6B, 6C, and 6D, an angle rotated clockwise may be positive and an angle rotated counterclockwise may be negative.

Referring to FIG. 6B, the first posture-position sensor 650 may measure a direction of gravity with respect to a first reference direction as a first direction angle 621. In addition, the second posture-position sensor 660 may measure a direction of gravity with respect to a second reference direction as a second direction angle 622. The controller 400 may determine a position of the radiation detector 100 with respect to the object 130 based on at least one of a first direction angle 621 and a second direction angle 622. For example, since a first direction angle 621 is 90 degrees, the controller 400 may determine that the radiation detector 100 is positioned at a lower side with the object 130 as a center.

Referring to FIG. 6C, the first posture-position sensor 650 may measure a direction of gravity with respect to a first reference direction as a first direction angle 631. In addition, the second posture-position sensor 660 may measure a direction of gravity with respect to a second reference direction as a second direction angle 632. The controller 400 may determine a position of the radiation detector 100 with respect to the object 130 based on at least one of a first direction angle 631 and a second direction angle 632. For example, since a first direction angle 631 is 0 degrees, the controller 400 may determine that the radiation detector 100 is positioned at a left side with the object 130 as a center.

Referring to FIG. 6D, the first posture-position sensor 650 may measure a direction of gravity with respect to a first reference direction as a first direction angle 641. In addition, the second posture-position sensor 660 may measure a direction of gravity with respect to a second reference direction as a second direction angle 642. The controller 400 may determine a position of the radiation detector 100 with respect to the object 130 based on at least one of a first direction angle 641 and a second direction angle 642. For example, since a first direction angle 641 is-90 degrees, the controller 400 may determine that the radiation detector 100 is positioned at an upper side with the object 130 as a center. For reference, in FIGS. 6A, 6B, 6C, and 6D, an angle rotated clockwise may be positive and an angle rotated counterclockwise may be negative.

As described above, the radiation detector 100 may determine a position of the radiation detector 100 using an acceleration sensor. The radiation detector 100 may also determine a position of the radiation detector 100 with respect to the object 130 using a gyro sensor included in a posture-position sensor 511. A gyro sensor may measure angular velocity. The radiation detector 100 may be positioned at a predetermined initial position with respect to the object 130. Thereafter, the radiation detector 100 may determine a position of the radiation detector 100 with respect to the object 130 by integrating an angular velocity measured by a gyro sensor. A position of the radiation detector 100 may be an angle by which the radiation detector 100 is rotated from an initial position around a rotation axis 350 positioned inside the object 130. The radiation detector 100 may determine a position of the radiation detector in real time using a gyro sensor. The radiation detector 100 can determine a position of the radiation detector with respect to the object 130 using a gyro sensor regardless of whether a second direction is perpendicular to the ground.

A gyro sensor estimates an angle by integrating an angular velocity. When integrating an angle, a cumulative error occurs so that a drift phenomenon occurs in a low-frequency band, and an acceleration sensor has noise in a high-frequency band, so it may be difficult to expect an accurate value in some cases. A complementary filter calculates an angle by combining an acceleration value having high-frequency noise and a gyro value having low-frequency noise, so that accurate calculation can be performed. That is, the radiation detector 100 of the present disclosure may determine a degree of bending of a radiation detection panel 110 or a position of a radiation detection panel 110 using both a gyro sensor and an acceleration sensor.

The radiation detector 100 of the present disclosure may use an Euler angle in order to determine a degree of bending of a radiation detection panel 110 or a position of a radiation detection panel 110. The Euler angle has a problem called Gimbal lock. Gimbal lock means that rotation of one axis affects another axis to lose a component (direction). In order to solve such a problem, the radiation detector 100 of the present disclosure may apply a Quaternion calculation.

When a second direction is perpendicular to the ground, the controller 400 may perform a step of determining a position of a radiation detection panel with respect to an object using at least one of a geomagnetic sensor and a gyro sensor included in a posture-position sensor. Since a method for determining a position of a radiation detection panel 110 using a gyro sensor has already been described, hereinafter, a method for using a geomagnetic sensor will be described.

A geomagnetic sensor may be a configuration for determining which direction of east, west, south, and north the radiation detector 100 faces. For example, a geomagnetic sensor may be a configuration for determining which direction of east, west, south, and north a third direction of the radiation detector 100 faces. A third direction may be a direction perpendicular to a first direction and a second direction. A third direction may represent a front side of the radiation detector 100. However, it is not limited thereto, and a third direction may represent a rear side of the radiation detector 100.

In the present disclosure, a third direction may be a direction based on the radiation detector 100. It should be noted that the third direction is not a direction fixed with respect to the ground. According to a direction in which the radiation detector 100 is placed with respect to the ground, the third direction may face a different direction with respect to the ground. For example, when a surface of the radiation detector 100 is parallel to the ground, a third direction may be a direction perpendicular to the ground. When the surface of the radiation detector 100 is perpendicular to the ground, a third direction may be a direction parallel to the ground.

As such, the radiation detector 100 can determine a position of the radiation detector 100 with respect to the object 130 regardless of an extension direction of the object 130. Therefore, a user can perform a thorough inspection on the object 130. In addition, even if there is a position that a user has missed and not inspected, an inspection can be performed again later. The radiation detector 100 can acquire information on whether there is an abnormality in the object 130 through a predetermined model. In addition, when the information on whether there is an abnormality indicates that there is an abnormality in the object 130, the radiation detector 100 may store a position where there is an abnormality. That is, the radiation detector 100 may store a position of the radiation detector 100 with respect to the object 130 where an abnormality is found. The radiation detector 100 may output a position of the radiation detector 100 where an abnormality is found. After maintenance on the abnormality is performed, a user can inspect only a position where an abnormality was found again. Since it is not necessary to inspect the entirety of the object 130, work efficiency of inspection of the object 130 can be significantly increased.

In order to accurately calculate a position and a posture, the radiation detector 100 may perform the following steps.

The radiation detector 100 may perform initialization. When starting operation, the radiation detector 100 may initialize a basic error of an acceleration sensor based on at least one of received gravitational acceleration and acceleration sensor data. More specifically, a radiation detector 100 of the present disclosure may include a process of calculating an accurate position and direction of the radiation detector 100 by combining a plurality of sensors (a gyro sensor and/or an acceleration sensor) and reducing an error of sensor data acquired from the plurality of sensors.

The radiation detector 100 may perform orientation calculation. Here, an orientation of the radiation detector 100 may correspond to an initial position of the radiation detector 100 with respect to an object 130. The radiation detector 100 may calculate an orientation (including a slope, or a direction, etc.) of the radiation detector 100 using data provided by a gyro sensor. The radiation detector 100 may generate a position transformation matrix representing how the radiation detector 100 has changed a direction based on the calculated orientation. A value measured by a gyro sensor will change according to a change in position of the radiation detector 100, and a position transformation matrix may be used for the radiation detector 100 to acquire a current position of the radiation detector 100 based on a current measured value of the gyro sensor. That is, the radiation detector 100 may acquire a current position of the radiation detector 100 by applying a current measured value of a gyro sensor to a position transformation matrix.

The radiation detector 100 may perform velocity calculation. More specifically, the radiation detector 100 may calculate velocity of the radiation detector 100 using data measured by an acceleration sensor.

The radiation detector 100 may perform error estimation. The radiation detector 100 may estimate and correct errors that may occur in a gyro sensor and an acceleration sensor using a filter. In this process, errors in orientation and velocity of the radiation detector 100 may also be corrected.

The radiation detector 100 may perform position calculation. The radiation detector 100 may calculate a position of the radiation detector 100 by utilizing orientation and velocity. In order to calculate a position of the radiation detector 100, the radiation detector 100 may apply at least one of orientation and velocity to a position transformation matrix. The radiation detector 100 may estimate an error in a calculated position of the radiation detector 100 and correct it through a filter. More specifically, the radiation detector 100 may acquire a plurality of positions of radiation detector 100 based on measured values of a plurality of gyro sensors and at least two values among a plurality of acceleration sensors, estimate an error based on the plurality of positions of radiation detector 100, and acquire the final plurality of positions of the radiation detector 100 by applying a filter.

According to various embodiments of the present disclosure, the controller 400 may determine a first position included in a position of a radiation detection panel with respect to an object using at least one of an acceleration sensor and a gyro sensor included in a posture-position sensor. In addition, the controller 400 may determine a second position included in the position of the radiation detection panel with respect to the object using at least one of a geomagnetic sensor and a gyro sensor included in the posture-position sensor. The radiation detector 100 may acquire a position vector based on a first position and a second position. The radiation detector 100 may determine a position of the radiation detector 100 with respect to the object 130 in three dimensions based on a position vector. That is, regardless of an extension direction of the object 130, the radiation detector 100 can acquire a position of the radiation detector 100 with respect to the object 130 in three dimensions.

As such, the radiation detector 100 can acquire a position of the radiation detector 100 with respect to the object 130 and cause it to be output from an output unit. A user can check where a currently imaged position is through an output unit. In addition, the radiation detector 100 may store an inspection plan. The radiation detector 100 may store a position requiring an inspection in the object 130. The radiation detector 100 may also output whether an imaging position corresponds to a position requiring an inspection on an inspection plan. When an imaging position corresponds to a position requiring an inspection on an inspection plan, the radiation detector 100 may be switched to an imaging mode. That is, the radiation detector 100 may be in a state in which radiation can be irradiated. A user can image an image of the object 130 at an accurate position on an inspection plan. Therefore, an inspection can be accurately performed according to an inspection plan.

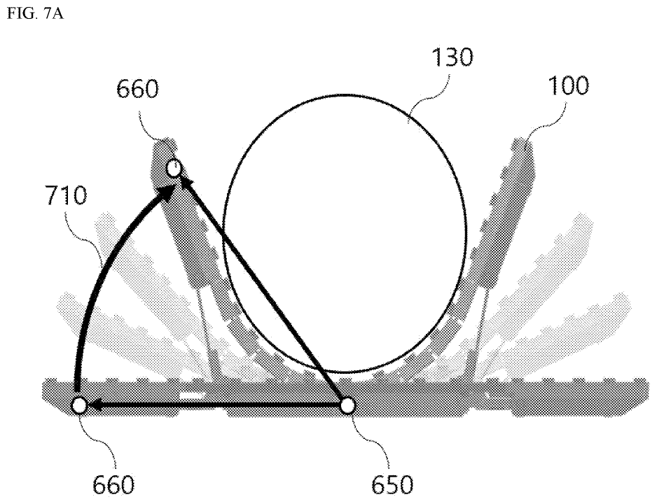

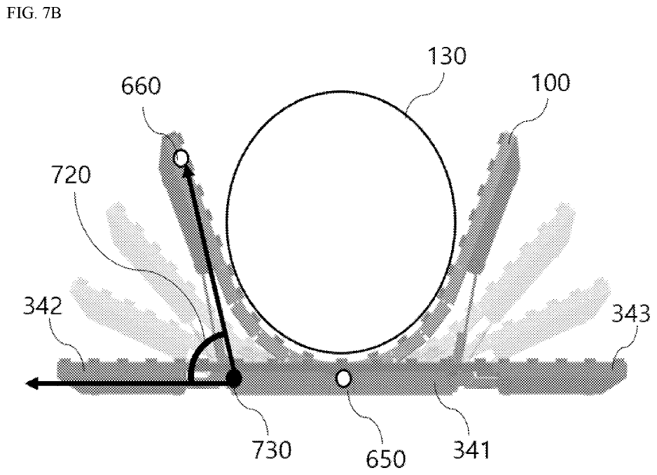

FIGS. 7A and 7B are views for explaining a degree of bending of a radiation detector according to an embodiment of the present disclosure.

A controller 400 included in the radiation detector 100 may perform a step of acquiring a degree of bending of a radiation detection panel with respect to a predetermined initial posture based on a posture-position sensor. Here, an initial posture may be a state in which the radiation detector 100 is flat or a state in which a radiation detection panel 110 is flat. A degree of bending of the radiation detection panel 110 may correspond to a degree of bending of the radiation detector 100.

A degree of bending of a radiation detector may be information related to curvature of the radiation detector. A degree of bending of a radiation detector of the present disclosure may include at least one of rotation information 710 of a sensor and angle information 720 of a bending support unit.

FIG. 7A may be a view for explaining rotation information 710 of a sensor. Rotation information of a sensor may be acquired based on at least one of an acceleration sensor, a gyro sensor, and a geomagnetic sensor. Rotation information of a sensor may represent a degree of rotation of a second posture-position sensor 660 with respect to a sensor rotation axis. A sensor rotation axis may be a predetermined point. For example, a sensor rotation axis may be positioned at a first posture-position sensor 650. However, it may be different from a position of the first posture-position sensor 650. The radiation detector 100 may be considered to be bent more as the rotation information 710 of a sensor has a larger value.

FIG. 7B may be a view for explaining angle information 720 of a bending support unit. A bending support unit may include a joint 730. The joint 730 may be a structure for coupling a central rear cover 341 and side rear covers 342, 343. Angle information 720 of a bending support unit may represent a degree of rotation of the joint 730. Information on rotation of the joint 730 may be measured by at least one of a potentiometer, an acceleration sensor, a gyro sensor, and a geomagnetic sensor.

Hereinafter, a process of acquiring a degree of bending of a radiation detector using an acceleration sensor, a gyro sensor, and a geomagnetic sensor will be described. There may be a plurality of posture-position sensors. One posture-position sensor may be positioned on a central rear cover, and another posture-position sensor may be positioned on a side rear cover. However, it is not limited thereto, and even if posture-position sensors are at different positions, a degree of bending of a radiation detector can be acquired in a similar manner. Hereinafter, a description will be given based on a case where one posture-position sensor is positioned on a central rear cover and another posture-position sensor is positioned on a side rear cover.

First, a process of acquiring a degree of bending of a radiation detector based on an acceleration sensor will be described.

The radiation detector 100 may acquire a degree of bending of the radiation detector based on information measured by a posture-position sensor. The radiation detector 100 may acquire a degree of bending of the radiation detector based on a value obtained by subtracting a second direction angle measured by a second posture-position sensor 660 from a first direction angle measured by a first posture-position sensor 650.

For example, referring to FIG. 6A, a first posture-position sensor 650, which is an acceleration sensor, may measure a direction of gravity with respect to a first reference direction as a first direction angle 611. In addition, a second posture-position sensor 660, which is an acceleration sensor, may measure a direction of gravity with respect to a second reference direction as a second direction angle 612. For example, since a first direction angle 611 is 180 degrees, the controller 400 may measure a degree of bending 613 of the radiation detector based on a value obtained by subtracting a second direction angle 612 from 180 degrees. For reference, in FIGS. 6A, 6B, 6C, and 6D, an angle rotated clockwise may be positive and an angle rotated counterclockwise may be negative.

Next, a process of acquiring a degree of bending of a radiation detector based on a geomagnetic sensor will be described.

The radiation detector 100 may acquire a degree of bending of the radiation detector based on information measured by a posture-position sensor. The radiation detector 100 may acquire a degree of bending of the radiation detector based on a value obtained by subtracting a second direction angle measured by a second posture-position sensor 660 from a first direction angle measured by a first posture-position sensor 650.

A first posture-position sensor 650, which is a geomagnetic sensor, may measure a magnetic north pole direction with respect to a first reference direction as a first direction angle. A first direction angle may mean a value measured by the first posture-position sensor 650. In the present embodiment, a magnetic north pole direction is used, but it is not limited thereto. In addition, a second posture-position sensor 660 may measure a magnetic north pole direction with respect to a second reference direction as a second direction angle. A second direction angle may mean a value measured by the second posture-position sensor 660. The controller 400 may measure a degree of bending of the radiation detector based on a value obtained by subtracting a second direction angle from a first direction angle.

Next, a process of acquiring a degree of bending of a radiation detector based on a gyro sensor will be described.

The radiation detector 100 may acquire a degree of bending of the radiation detector based on information measured by a posture-position sensor. The radiation detector 100 may acquire a degree of bending of the radiation detector based on a value obtained by subtracting a second direction angle measured by a second posture-position sensor 660 from a first direction angle measured by a first posture-position sensor 650.

A first posture-position sensor 650, which is a gyro sensor, may integrate a measured rotation velocity and measure it as a first direction angle. In addition, a second posture-position sensor 660 may integrate a measured rotation velocity and measure it as a second direction angle. The controller 400 may measure a degree of bending of the radiation detector based on a value obtained by subtracting a second direction angle from a first direction angle.

The radiation detector 100 may measure a degree of bending of the radiation detector based on at least one of a first sensor value measured by an acceleration sensor, a second sensor value measured by a geomagnetic sensor, and a third sensor value measured by a gyro sensor. For example, the radiation detector 100 may store an angle table in which at least one of a first sensor value, a second sensor value, and a third sensor value is correlated to a degree of bending. The radiation detector 100 may determine a degree of bending by applying at least one of a first sensor value, a second sensor value, and a third sensor value to an angle table.

The radiation detector 100 may determine a degree of bending using a geomagnetic sensor instead of at least one of a gyro sensor or an acceleration sensor when an extension direction of an object is a predetermined threshold angle or more with respect to the ground.

In addition, the radiation detector 100 may determine a bending angle using at least one of a gyro sensor or an acceleration sensor when an extension direction of an object is less than a predetermined threshold angle with respect to the ground.

However, it is not limited thereto, and the radiation detector 100 may determine a weight w0 for a geomagnetic sensor or a weight w1 for a gyro sensor or an acceleration sensor included in predetermined weights according to an extension direction of an object. w0 may increase as an angle of an extension direction of an object with respect to the ground increases. w1 may decrease as an angle of an extension direction of an object with respect to the ground increases. w0+w1 may be 1. However, it is not limited thereto, and w0+w1 may be smaller than 1 or larger than 1. A degree of bending may be determined by the following equation.

$$degree of bending = w 0 * ( degree of bending by geomagnetic sensor ) + w 1 * ( bending angle by gyro sensor or acceleration sensor )$$

When w0 and w1 are used as described above, a degree of bending can be accurately measured. This is because a degree of bending by a geomagnetic sensor can be more accurate as an extension direction of an object is more perpendicular to the ground.

As described above, a degree of bending of a radiation detector can be measured using various types of sensors. The radiation detector 100 may measure a degree of bending of the radiation detector using at least one type of sensor. As a plurality of types of sensors are used, the degree of bending of the radiation detector can be accurately measured by supplementing each other.

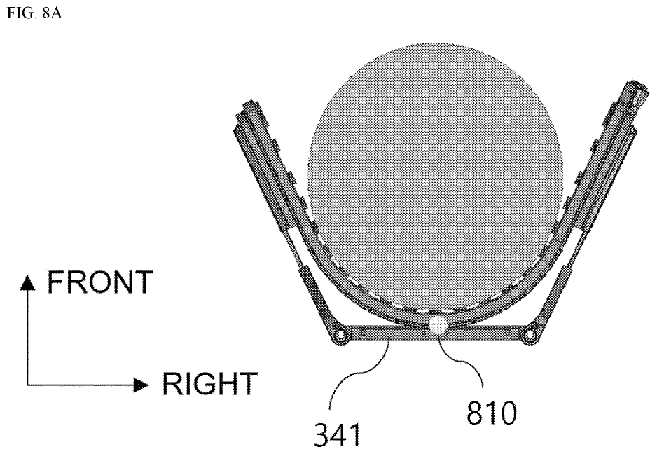

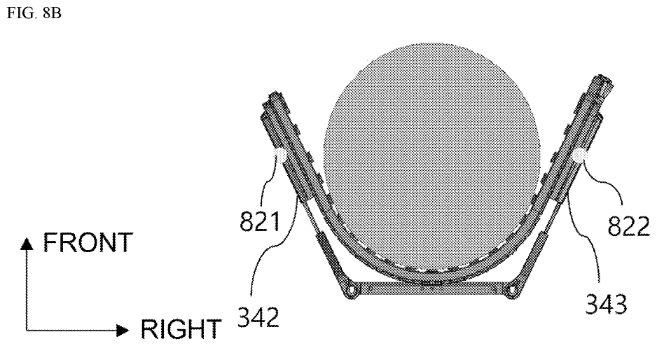

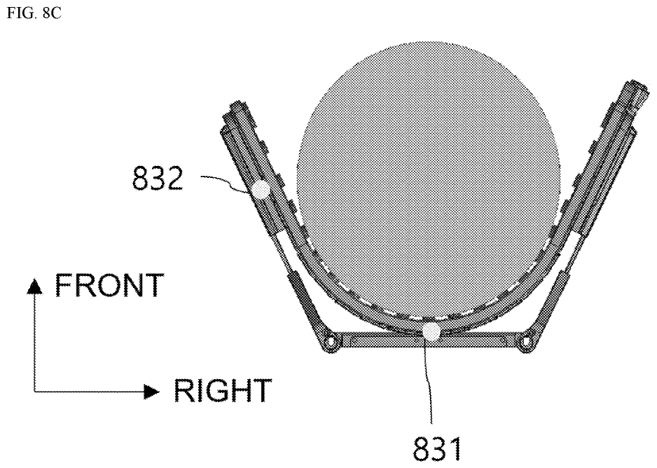

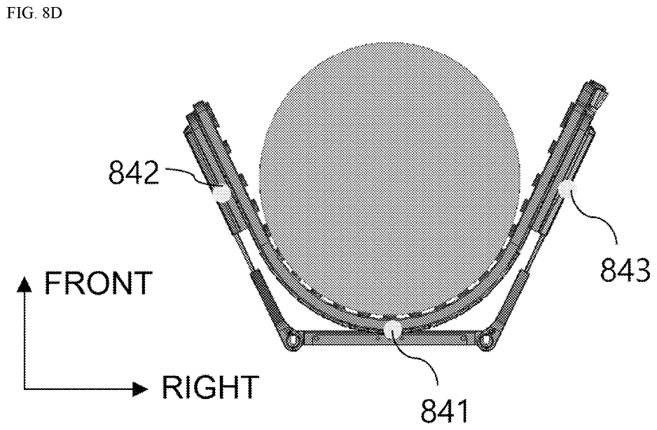

FIGS. 8A, 8B, 8C, and 8D are views for explaining a position of a posture-position sensor according to an embodiment of the present disclosure.

As already described, a posture-position sensor may include at least one of an acceleration sensor, a gyro sensor, and a geomagnetic sensor.

Referring to FIG. 8A, the radiation detector 100 may include one posture-position sensor 810. The posture-position sensor 810 may be positioned on a bending support unit 120. More specifically, the posture-position sensor 810 may be positioned on a central rear cover included in the bending support unit 120.

Referring to FIG. 8B, the radiation detector 100 may include a plurality of posture-position sensors 821, 822. The plurality of posture-position sensors 821, 822 may be positioned on the bending support unit 120. More specifically, a posture-position sensor 821 may be positioned on a left side rear cover 342 included in the bending support unit 120. A posture-position sensor 822 may be positioned on a right side rear cover 343 included in the bending support unit 120.

Referring to FIG. 8C, the radiation detector 100 may include a plurality of posture-position sensors 831, 832. The plurality of posture-position sensors 831, 832 may be positioned on the bending support unit 120. More specifically, a posture-position sensor 831 may be positioned on a central rear cover 341 included in the bending support unit 120. A posture-position sensor 832 may be positioned on a left side rear cover 342 included in the bending support unit 120.

Referring to FIG. 8D, the radiation detector 100 may include a plurality of posture-position sensors 841, 842, 843. The plurality of posture-position sensors 841, 842, 843 may be positioned on the bending support unit 120. More specifically, a posture-position sensor 841 may be positioned on a central rear cover 341 included in the bending support unit 120. A posture-position sensor 842 may be positioned on a left side rear cover 342 included in the bending support unit 120. A posture-position sensor 843 may be positioned on a right side rear cover 343 included in the bending support unit 120.

As such, since the radiation detector 100 of the present disclosure may include posture-position sensors at various positions, flexibility of implementation can be high. That is, by mounting posture-position sensors in various manners according to a place of use of the radiation detector 100, at least one of a degree of bending of a radiation detection panel or a position of a radiation detection panel with respect to an object can be accurately determined.

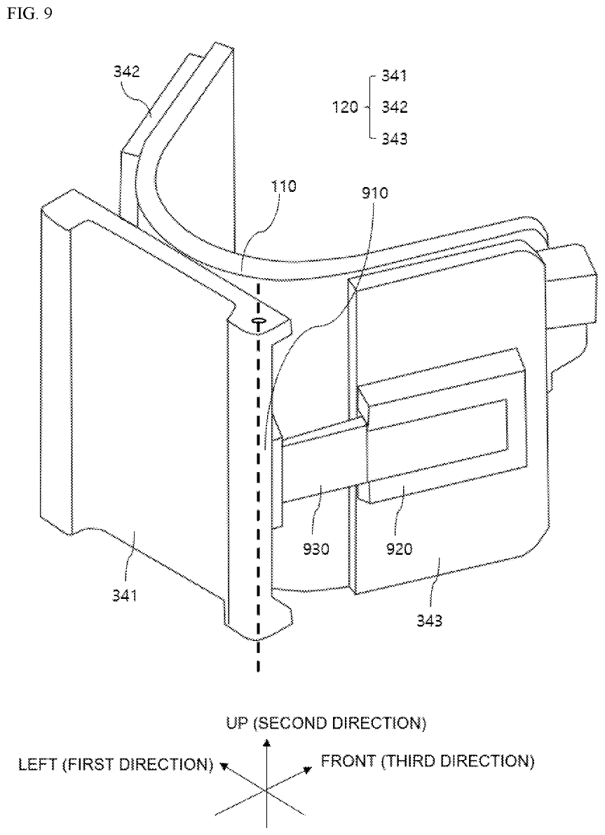

FIG. 9 is a view for explaining a method for determining an angle of a radiation detector according to an embodiment of the present disclosure.

A bending support unit 120 may include a central rear cover 341 and side rear covers 342, 343 rotatable with respect to the central rear cover 341 based on an axis parallel to a second direction.

A posture-position sensor may include a potentiometer. A potentiometer may output a different potentiometer output value as the side rear covers 342, 343 rotate with respect to the central rear cover 341. A controller 400 may determine a degree of bending of a radiation detection panel based on a potentiometer output value.

A potentiometer may be positioned at a joint 910 positioned between a central rear cover 341 and a side rear cover 342 or 343. A joint may be a structure for rotating a side rear cover 342 or 343 with respect to the central rear cover 341. A potentiometer may measure a rotation angle of a side rear cover 342 or 343 with respect to the central rear cover 341. The controller 400 may determine a degree of bending of a radiation detection panel 110 based on the measured rotation angle.

A potentiometer may be included in at least one of a first joint and a second joint. A first joint is positioned on a central rear cover 341 and a left side rear cover 342, and a second joint may be positioned on the central rear cover 341 and a right side rear cover 343. In a radiation detector, a first joint and a second joint may be bent at the same angle by a mechanical structure. In this case, a potentiometer may be positioned at one of a first joint and a second joint. However, it is not limited thereto, and a first joint and a second joint may be bent at different angles. When a first joint and a second joint can be bent at different angles, potentiometers may be positioned at both a first joint and a second joint.

The radiation detector 100 may determine a diameter of an object 130 based on a potentiometer. The radiation detector 100 may select a diameter of an object corresponding to a value of a potentiometer positioned at at least one of a first joint and a second joint from a predetermined diameter determination table.

A potentiometer may be included in at least one of a sliding guide unit 920 and a sliding unit 930. A sliding unit 930 may move to a sliding guide unit 920 while a side rear cover 342 or 343 rotates with respect to a central rear cover 341. A potentiometer may measure a position of the sliding unit 930 with respect to the sliding guide unit 920. The controller 400 may determine a degree of bending of the radiation detection panel 110 based on the measured position of the sliding unit 930. The sliding unit 930 may be a configuration connecting a central rear cover 341 and a side rear cover 342 or 343.

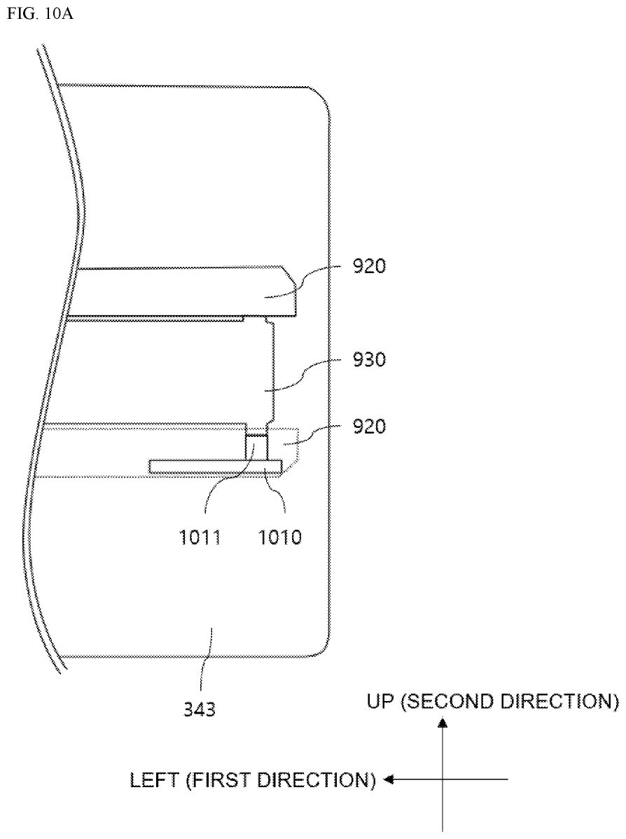

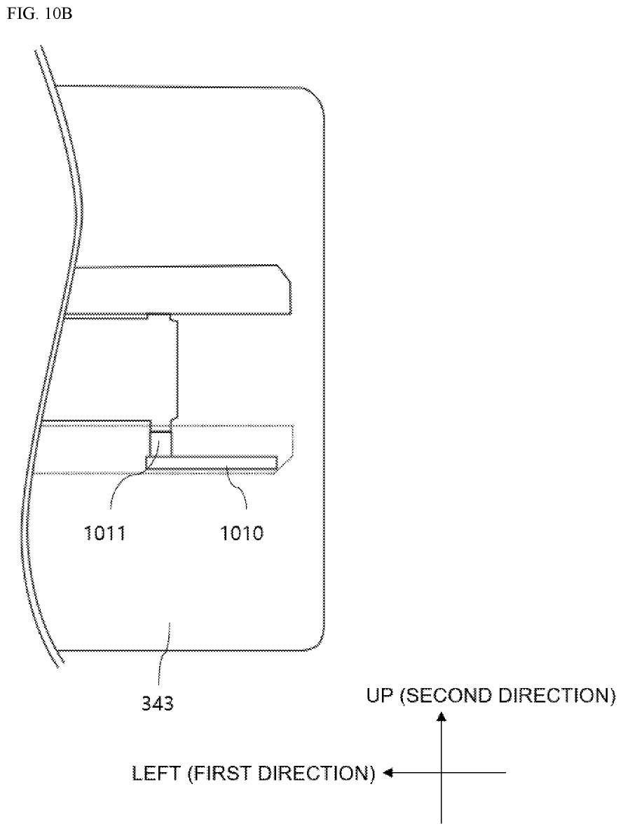

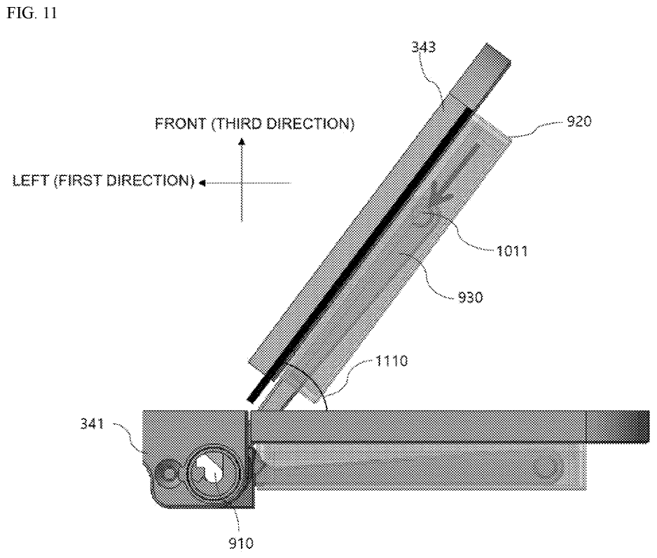

FIGS. 10A and 10B may be a view for explaining a radiation detector according to an embodiment of the present disclosure. FIG. 11 may be a view for explaining a radiation detector according to an embodiment of the present disclosure.

The bending support unit 120 may include a central rear cover 341 and a side rear cover 342 or 343 rotatable with respect to the central rear cover based on an axis parallel to a second direction.

Referring to FIGS. 9 to 11, the bending support unit 120 may include a sliding guide unit 920. The sliding guide unit 920 may be coupled to a rear of the side rear cover 342 or 343. The sliding guide unit 920 may include a potentiometer 1010 included in a posture-position sensor. The potentiometer 1010 may be a linear potentiometer. A potentiometer output value, which is an output of the potentiometer, may vary according to movement of a knob 1011 included in the potentiometer 1010. The potentiometer output value may be, for example, a resistance. The controller 400 may acquire a position of the knob 1011 by measuring the potentiometer output value. In addition, the controller 400 may determine a degree of bending of the radiation detection panel 110 based on the position of the knob 1011.

Referring to FIGS. 9 to 11, the bending support unit 120 may include a sliding unit 930. One side of the sliding unit 930 may be coupled to the central rear cover 341. That is, one side of the sliding unit 930 may be coupled to a joint 910. In addition, another side of the sliding unit 930 may be coupled to the potentiometer 1010. The sliding unit 930 may be coupled to the knob 1011 of the potentiometer 1010. Accordingly, when the sliding unit 930 moves along the sliding guide unit 920, the knob may also move along the sliding guide unit 920. The sliding unit 930 may be slidably coupled to the sliding guide unit 920.

When the bending support unit 120 is bent or unfolded, the sliding unit 930 may slide along the sliding guide unit 920. For example, referring to FIG. 10A, when the bending support unit 120 is unfolded, the other side of the sliding unit 930 may be positioned in a direction opposite to a first direction. That is, the knob 1011 may also be positioned in a direction opposite to the first direction. Referring to FIG. 10B, as the bending support unit 120 is bent more, the other side of the sliding unit 930 may move toward the first direction. That is, the knob 1011 may also move in the first direction.

When the sliding unit 930 slides along the sliding guide unit 920, a potentiometer output value of the potentiometer 1010 may be changed. As already described, the sliding unit 930 may be coupled to the knob 1011 of the potentiometer 1010. Accordingly, when the sliding unit 930 moves along the sliding guide unit 920, the knob 1011 may also move along the sliding guide unit 920. The potentiometer output value, which is the output of the potentiometer, may be changed by movement of the knob 1011.

The controller 400 may determine a degree of bending 1110 of the radiation detection panel based on the potentiometer output value. The controller 400 may store a degree of bending determination table or a degree of bending determination function that correlates the potentiometer output value to the degree of bending 1110. The controller 400 may determine the degree of bending 1110 of the radiation detection panel by applying the potentiometer output value to the degree of bending determination table or the degree of bending determination function.

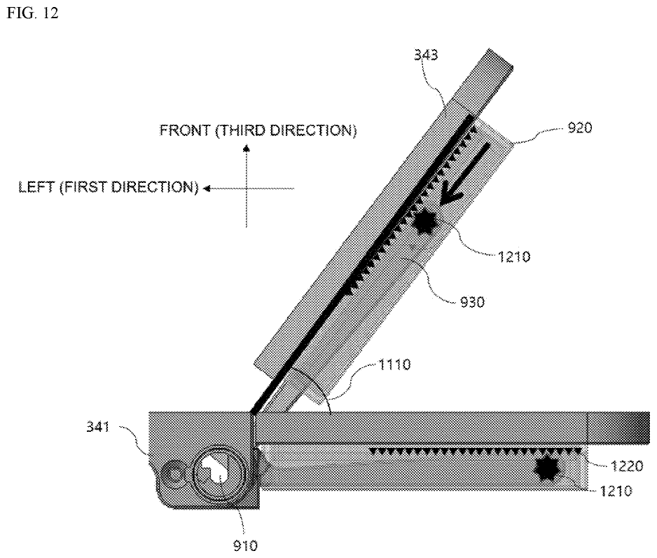

FIG. 12 may be a view for explaining a radiation detector according to an embodiment of the present disclosure.

Referring to FIGS. 9 and 12, the bending support unit 120 may include a central rear cover 341 and a side rear cover 342 or 343 rotatable with respect to the central rear cover based on an axis parallel to a second direction.

Referring to FIGS. 9 and 12, the bending support unit 120 may include a sliding guide unit 920 coupled to a rear of the side rear cover 342 or 343 and including a rack gear 1220.

In addition, the bending support unit 120 may include a sliding unit 930. One side of the sliding unit 930 may be coupled to the central rear cover 341. That is, one side of the sliding unit 930 may be coupled to a joint 910. Another side of the sliding unit 930 may be coupled to a potentiometer included in a posture-position sensor. The potentiometer may include a pinion gear 1210. When the pinion gear 1210 rotates, a potentiometer output value, which is an output of the potentiometer, may be changed. The sliding unit 930 may be slidably coupled to the sliding guide unit 920.

When the bending support unit 120 is bent or unfolded, the sliding unit 930 may slide along the sliding guide unit 920. When the sliding unit 930 slides along the sliding guide unit 920, the pinion gear 1210 coupled to the potentiometer may rotate by being engaged with the rack gear 1220. As the pinion gear 1210 rotates, the potentiometer output value may be changed. That is, the potentiometer output value may be related to a position of the sliding unit 930 with respect to the sliding guide unit 920.

For example, as the bending support unit 120 is unfolded more, the pinion gear 1210 of the sliding unit 930 may rotate in a counterclockwise direction. In addition, as the bending support unit 120 is bent more, the pinion gear 1210 of the sliding unit 930 may rotate in a clockwise direction.

The controller 400 may determine a degree of bending of the radiation detection panel based on the potentiometer output value. More specifically, the controller 400 may store a degree of bending determination table or a degree of bending determination function that correlates the potentiometer output value to a degree of bending 1110. The controller 400 may determine the degree of bending 1110 of the radiation detection panel by applying the potentiometer output value to the degree of bending determination table or the degree of bending determination function.

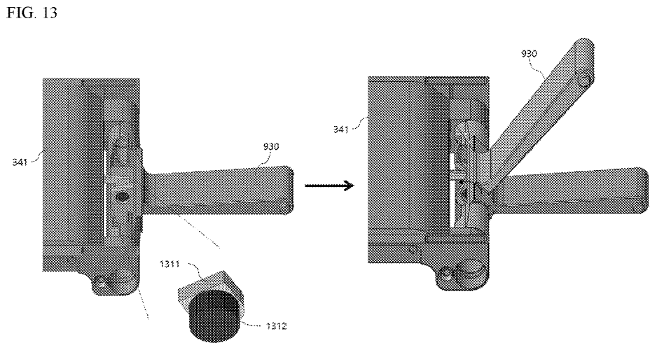

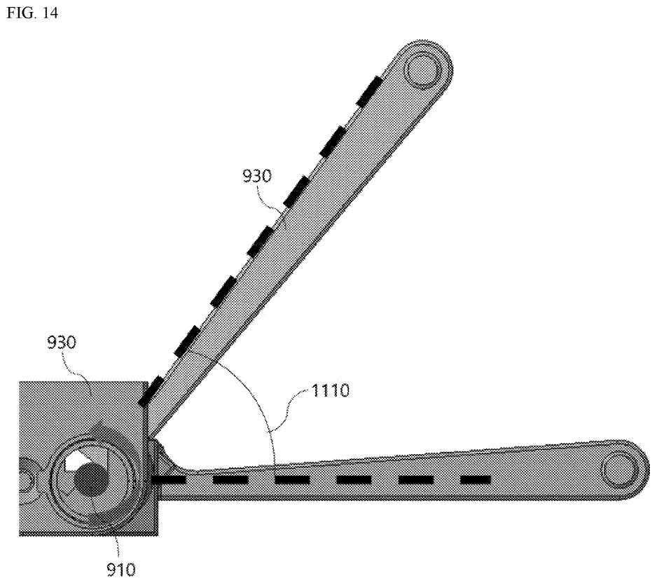

FIG. 13 may be a view for explaining a radiation detector according to an embodiment of the present disclosure. FIG. 14 may be a view for explaining a radiation detector according to an embodiment of the present disclosure.

Referring to FIGS. 9, 13, and 14, a potentiometer included in a posture-position sensor may be positioned at a joint 910. The joint 910 may be positioned between a central rear cover 341 and a side rear cover 342 or 343.

A fixed part 1311 of the potentiometer may be fixed to the central rear cover 341. In addition, a rotating part 1312 of the potentiometer may be coupled to one of the side rear cover 342 or 343 and the sliding unit 930.

When the bending support unit 120 is bent, one of the side rear cover 342 or 343 and the sliding unit 930 may rotate with respect to the central rear cover 341. At this time, the rotating part 1312 of the potentiometer may rotate with respect to the fixed part 1311 of the potentiometer. The potentiometer output value, which is the output of the potentiometer, may be changed according to rotation of the rotating part 1312.

The controller 400 may determine a degree of bending of the radiation detection panel based on the potentiometer output value. More specifically, the controller 400 may store a degree of bending determination table or a degree of bending determination function that correlates the potentiometer output value to a degree of bending 1110. The controller 400 may determine the degree of bending 1110 of the radiation detection panel by applying the potentiometer output value to the degree of bending determination table or the degree of bending determination function.

In the simple manner as described above, the radiation detector 100 may acquire a degree of bending of the radiation detection panel. Based on this, the radiation detector 100 may determine a lifespan of the radiation detector and may determine whether or not the radiation detector 100 is currently imaging. Accordingly, a user can easily maintain the radiation detector 100, and convenience can be increased because input during imaging is minimized.

Hereinafter, an operating method of a radiation detector will be described in more detail.

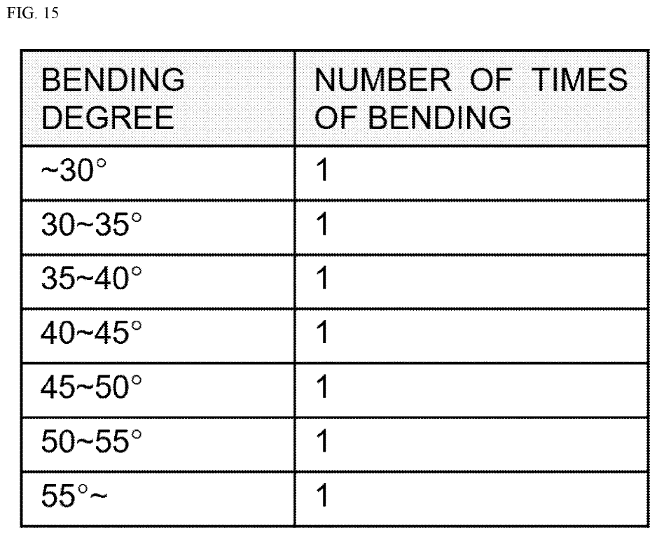

FIG. 15 is a view for explaining an operation of a radiation detector according to an embodiment of the present disclosure.

Referring to FIG. 15, a controller 400 may determine a number of times of bending for each bending degree based on bending information of a radiation detection panel 110. The number of times of bending may represent a number of times the radiation detection panel is bent and then unfolded again. The number of times of bending may not increase until the radiation detection panel is unfolded again after being bent.

A bending degree may mean a degree to which the radiation detection panel 110 is maximally bent when one time of bending is performed. The degree to which it is bent may mean the angle described in FIGS. 7A and 7B. The number of times of bending for each bending degree may be accumulated and stored. Referring to FIG. 15, it may mean that there was one time where the bending degree was 55 degrees or more and there was one time where it was 50 degrees or more and less than 55 degrees.

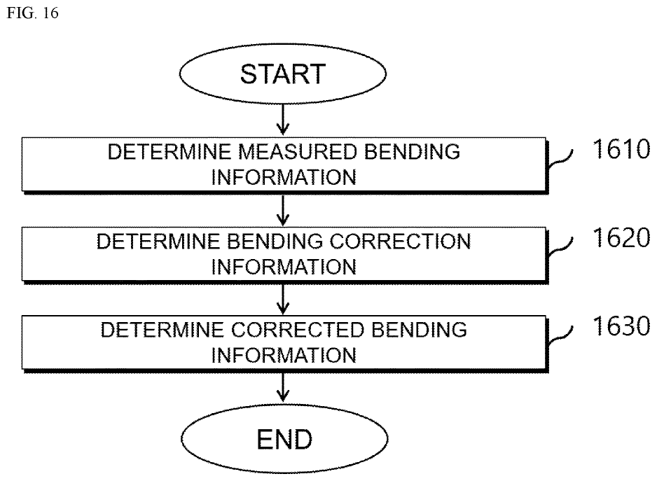

FIG. 16 is a flowchart showing an operating method of a radiation detector according to an embodiment of the present disclosure.

The controller 400 may determine that a force applied to bending is larger as a degree of bending of the radiation detection panel 110, which is flexible, indicates more bending. The more the radiation detection panel 110 is in a bent state, the larger force must be applied to be further bent. In addition, as the radiation detection panel 110 is in more of a bent state, stress applied to the radiation detection panel 110 may be larger. In addition, when the radiation detection panel 110 is maximally bent, it may no longer be bent even if a large force is applied. That the more the radiation detection panel 110 is in a bent state, the larger force must be applied to be further bent may be realized by a structure of the bending support unit 120. As such, since a larger force must be applied as the radiation detection panel 110 is in more of a bent state, it may not be easy for the radiation detection panel 110 to be bent much. That is, the radiation detection panel 110 may maintain an unfolded state as much as possible. A state in which the radiation detection panel 110 is bent may be a state of being stressed in terms of hardware. In addition, if a lot of stress is accumulated, the radiation detection panel 110 may malfunction. Since the radiation detector 100 of the present disclosure causes the radiation detection panel 110 to maintain an unfolded state as much as possible, a lifespan of the radiation detection panel 110 may be increased.

The controller 400 may perform a step 1610 of determining measured bending information related to a force required to bend the radiation detection panel 110. For example, the controller 400 may determine the measured bending information using at least one of a posture-position sensor or a separate force measurement sensor. The measured bending information may include acceleration.

According to various embodiments of the present disclosure, the measured bending information may be acquired based on the degree of bending of the radiation detection panel 110. The controller 400 may store a bending force determination table that correlates the degree of bending of the radiation detection panel 110 to the measured bending information. The controller 400 may acquire the measured bending information corresponding to the degree of bending of the radiation detection panel 110 from the bending force determination table.

The measured bending information may be a value measuring a force required for a user to bend the radiation detector 100. The measured bending information may be constant regardless of a posture (degree of bending) of the radiation detector 100. That is, the measured bending information may be a predetermined value. That is, the measured bending information may not be measured. However, it is not limited thereto.

The controller 400 may perform a step 1620 of determining bending correction information based on the degree of bending of the radiation detection panel 110. The controller 400 may store a correction information determination table that correlates the degree of bending of the radiation detection panel 110 to the bending correction information. The controller 400 may acquire the bending correction information corresponding to the degree of bending of the radiation detection panel 110 from the correction information determination table. The bending correction information may be a value for reflecting that a larger force is required to bend as the radiation detector 100 is in a bent state. In addition, the bending correction information may be a value for reflecting that stress increases as the radiation detection panel 110 is bent more. The bending correction information may have a larger value as the radiation detector 100 is bent more. However, it is not limited thereto, and the bending correction information may have a smaller value as the radiation detector 100 is bent more.

More specifically, the controller 400 may determine the bending correction information by multiplying a quotient, obtained by dividing the degree of bending of the radiation detection panel 110 by a predetermined unit variation, by a predetermined bending weight. The bending correction information may increase by the bending weight whenever the degree of bending of the radiation detection panel 110 indicates that it is bent by 10 degrees. That is, the predetermined unit variation may be 10 degrees.

The controller 400 may perform a step 1630 of determining corrected bending information by adding the bending correction information to the measured bending information. Since the bending correction information has a larger value as the radiation detector 100 is bent more, the corrected bending information may also have a larger value as the radiation detector 100 is bent more.

Units of measured bending information, bending correction information, and corrected bending information may be units of force or units of acceleration. However, it is not limited thereto.

As such, the radiation detector 100 can accurately measure a force applied to the radiation detector 100. In addition, the radiation detector 100 can accurately measure an external force applied to the radiation detection panel 110. The radiation detector 100 can also accurately measure a lifespan of the radiation detector 100 based on the corrected bending information. In addition, when the lifespan is almost at an end, the radiation detector 100 can inform a user of the same. Accordingly, a case where the radiation detector 100 suddenly does not operate at a site may not occur.

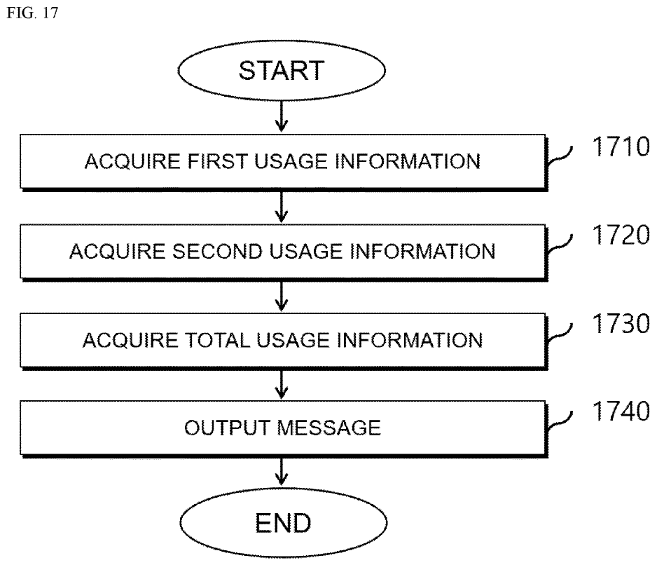

FIG. 17 is a flowchart showing an operating method of a radiation detector according to an embodiment of the present disclosure.

The controller 400 may determine total usage information of the radiation detector 100 based on at least one of a number of times of bending and a degree of bending. The total usage information may be in direct proportion to a total amount of stress received by the radiation detector 100.

The controller 400 may perform a step 1710 of acquiring first usage information obtained by multiplying corrected bending information corresponding to a first bending degree by a number of times of bending corresponding to the first bending degree. The first bending degree may be included in the bending degree described in FIG. 15. For example, the first bending degree may represent 30 degrees or more and 35 degrees or less.

If the first bending degree is a single value, the controller 400 may acquire the first usage information based on the value. However, when the first bending degree is a range, the controller 400 may acquire the first usage information based on a representative value of the first bending degree. That is, the first usage information may be acquired by multiplying a representative value of the first bending degree by the number of times of bending. A representative value of the first bending degree may be a minimum value, a median value, or a maximum value of the range of the first bending degree. For example, if the first bending degree represents 30 degrees or more and less than 35 degrees, a representative value that is a median value may be 32.5 degrees, and a representative value that is a minimum value may be 30 degrees. In addition, when the first bending degree represents less than 30 degrees, one of values of 0 degrees or more and less than 30 degrees may be selected as a representative value. For example, a representative value may be 15 degrees. When the first bending degree represents 55 degrees or more, one of values of 55 degrees or more and less than a maximum angle may be selected as a representative value. Here, a maximum angle may be an angle at which the radiation detector 100 can be maximally bent. A representative value may be, for example, a maximum angle.

Since the number of times of bending has already been described in FIG. 15, redundant description is omitted.

The controller 400 may perform a step 1720 of acquiring second usage information obtained by multiplying corrected bending information corresponding to a second bending degree by a number of times of bending corresponding to the second bending degree. The second bending degree may be included in the bending degree described in FIG. 15. The first bending degree may be different from the second bending degree. For example, if the first bending degree represents 30 degrees or more and less than 35 degrees, the second bending degree may represent 35 degrees or more and 40 degrees or less.

Since a method for determining a representative value of the second bending degree is the same as the method for determining a representative value of the first bending degree, redundant description is omitted.

The controller 400 may perform a step 1730 of acquiring total usage information obtained by adding the first usage information and the second usage information. In the present disclosure, it is described as adding only the first usage information and the second usage information, but it is not limited thereto. Usage information may be acquired for all bending degree sections. In addition, total usage information may be acquired by adding all usage information. For example, referring to FIG. 15, there are 7 sections for the bending degree. The controller 400 may acquire usage information for each section. For example, the controller 400 may acquire first usage information to seventh usage information. The controller 400 may acquire total usage information by adding all of the first usage information to the seventh usage information.

Total usage information may be information related to a lifespan of the radiation detector 100. It may mean that as the total usage information is higher, a remaining lifespan of the radiation detector 100 is shorter.

When the total usage information is larger than predetermined lifespan information, the controller 400 may perform a step 1740 of outputting a message for performing a check on the detector.

Above, the controller 400 acquired usage information by multiplying a bending degree and a number of times of bending, but it is not limited thereto. Usage information may be simply a number of times of bending. The controller 400 may perform a step 1730 of acquiring total usage information obtained by adding all numbers of times of bending corresponding to a bending degree. In addition, when the total usage information is larger than predetermined lifespan information, the controller 400 may perform a step 1740 of outputting a message for performing a check on the detector.

As such, since the radiation detector 100 informs of a lifespan of the radiation detector 100 in advance, a user can replace or repair the radiation detector 100 in advance before going to inspect an object. Accordingly, a case where the radiation detector 100 suddenly malfunctions at a site can be reduced. Particularly, the radiation detector 100 is used in a harsh external environment, the harsh external environment may be a place away from civilization, and inspection of an object is performed for several days to several weeks, so it may be very important to output a message for performing a check in advance.

According to various embodiments of the present disclosure, a degree of fast bending of the radiation detector 100 may be acquired in real time. For example, the radiation detector 100 may acquire a plurality of degrees of bending of the radiation detector 100 acquired for each unit time. The radiation detector 100 may acquire a standard deviation of a plurality of degrees of bending. It may mean that as a standard deviation is larger, it is bent more quickly. That the radiation detection panel 110 or the radiation detector 100 is bent quickly may be a major factor in shortening a lifespan of the radiation detection panel 110. Accordingly, when a standard deviation is a predetermined threshold deviation or more, the radiation detector 100 may increase the total usage information by a predetermined amount or decrease predetermined lifespan information.

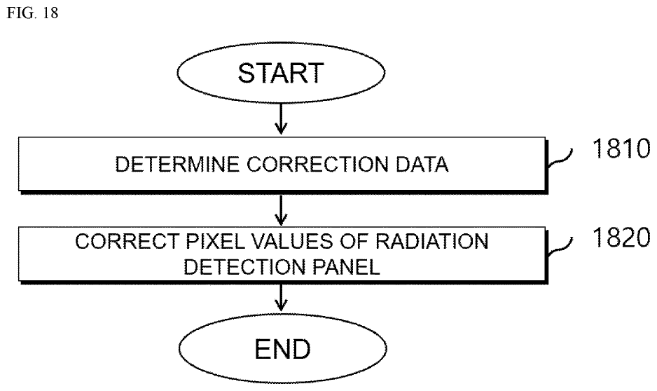

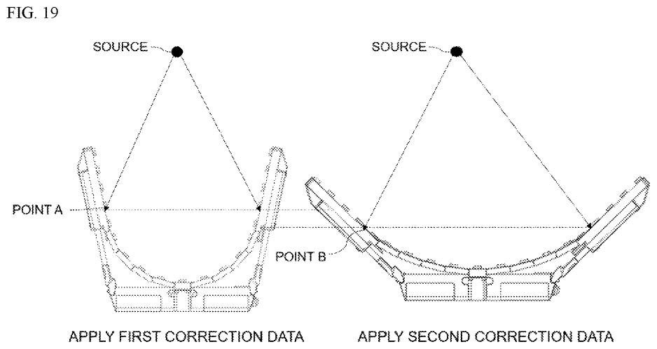

FIG. 18 is a flowchart showing an operating method of a radiation detector according to an embodiment of the present disclosure. In addition, FIG. 19 is a view for explaining an operating method of a radiation detector according to an embodiment of the present disclosure.

Referring to FIG. 18, the controller 400 may perform a step 1810 of determining correction data based on a degree of bending of the radiation detection panel 110.

In this regard, radiation input to the radiation detection panel 110 is converted into light by a phosphor, and the converted light is converted into an electrical signal through a photodiode designed on a TFT. This electrical signal is read out through a readout circuit and converted into a digital value through an analog to digital converter (ADC). The radiation detector 100 may acquire a collection of converted digital values as digital data. If the digital value is for one pixel, the digital data may be for a plurality of pixels. The radiation detector 100 may acquire a final image by applying image pre-processing to the digital data. At this time, pre-processing may be performed to obtain a flat image by correcting the radiation input to the radiation detector 100. That is, although an image is captured while the radiation detector 100 is bent, it is converted into a flat image so that it can be displayed on a display. Since an input amount of radiation reaching a pixel may vary according to the degree of bending of the radiation detector 100, the radiation detector 100 must apply different pre-processing based on the degree of bending to improve image quality.

More specifically, referring to FIG. 19, in the digital data acquired by the radiation detector 100, uniformity of an image according to a position of a pixel may vary according to the degree of bending. Therefore, different pre-processing (using different correction data) may be performed according to the degree of bending.

The reason why uniformity of various images varies is as follows. Point a and point b are points where the same pixel is positioned in one radiation detector 100. When the detector is greatly bent as shown in the left figure, a distance from a source to the point a is short. However, when the detector is gently bent as shown in the right figure, a distance from the source to the point b is long. That is, a radiation dose of the point b may be smaller than a radiation dose of the point a. In order to acquire a uniform image regardless of the degree of bending, pixel values acquired from the same pixel included in the radiation detector 100 must be processed differently according to the degree of bending of the radiation detector 100. What reflects this is correction data, and the correction data may be determined differently according to the degree of bending. The radiation detector 100 can always acquire a high-quality radiation image even if a bending angle is different based on the correction data.

The radiation detector 100 may acquire the degree of bending of the radiation detector 100 and automatically perform pre-processing based on the degree of bending of the radiation detector 100. Through this, convenience of a user is improved and an optimal image can be acquired.

The radiation detector 100 may store a plurality of candidate correction data respectively corresponding to a plurality of degrees of bending. The radiation detector 100 may acquire the degree of bending based on a posture-position sensor. In addition, the radiation detector 100 may select correction data corresponding to the degree of bending among the plurality of candidate correction data. For example, selection of the correction data may be as shown in the table below.

TABLE 1

| | Selection of correction data | | | | |
|---|---|---|---|---|---|
| 1 | Flat | = | L1 | | |
| 2 | 12 inch | < | L2 | < | Flat |
| 3 | 8 inch | < | L3 | ≤ | 12 inch |
| 4 | 6 inch | < | L4 | ≤ | 8 inch |
| 5 | 4 inch | ≤ | L5 | ≤ | 6 inch |

For example, when an object is flat and imaging is performed while a detector is not bent, correction data L1 may be used. In addition, when a diameter of a pipe exceeds 12 inches, the radiation detector may use correction data L2. In addition, when the diameter of the pipe exceeds 8 inches and is 12 inches or less, the radiation detector may use correction data L3. In addition, when the diameter of the pipe exceeds 6 inches and is 8 inches or less, the radiation detector may use correction data L4. In addition, when the diameter of the pipe is 4 inches or more and 6 inches or less, the radiation detector may use correction data L5. However, it is not limited thereto. As already described, the diameter of the pipe may be acquired based on a degree of bending of a radiation detector 100.

The correction data may be data for correcting at least one of a magnitude of radiation and a reception direction of radiation received by a pixel of a radiation detection panel according to a degree of bending of a radiation detection panel 110.

A radiation detector 100 may perform a step 1820 of correcting pixel values (digital data) of the radiation detection panel based on the correction data.

According to an embodiment of the present disclosure, a controller 400 may determine whether or not to be in a power saving mode based on a degree of bending of a radiation detection panel 110. When the radiation detection panel 110 is spread flat, the radiation detector 100 may turn off power or enter a power saving mode. A user may move the radiation detector 100 to an object inspection site in a flatly spread state. In addition, the user may store the radiation detector 100 in a flatly spread state. As such, since the radiation detector 100 is stored in a spread state for most of the time, stress applied to the radiation detection panel 110 may be small, and a lifespan of the radiation detector 100 can be prolonged.

When the radiation detection panel 110 is bent, the radiation detector 100 may turn on power or turn off a power saving mode. When the radiation detection panel 110 is bent by a predetermined threshold angle or more, the radiation detector 100 may turn on power or turn off a power saving mode. When the radiation detection panel 110 is bent, the radiation detector 100 may be in an imaging mode or an active mode. When the radiation detection panel 110 is bent by a predetermined threshold angle or more, the radiation detector 100 may be in an imaging mode or an active mode.

According to an embodiment of the present disclosure, a controller 400 may perform a step of determining whether or not an impact unintended by user has been applied based on a sensor value of a posture-position sensor. In addition, when a magnitude of an impact received from the posture-position sensor is a predetermined magnitude or more, the radiation detector 100 may output a message indicating to check the radiation detector. A user can confirm what happened when the radiation detector 100 was not used. For example, when the radiation detector 100 is moved by being placed in a cargo hold of an airplane, the user cannot know what happened in the cargo hold. When the radiation detector 100 is used to inspect the object 130 in such a damaged state, an accurate image of the object 130 may not be acquired. Since the radiation detector 100 of the present disclosure can identify a history that occurred when a user does not use the radiation detector, the radiation detector 100 can always maintain an optimal state of use.

Up to now, various embodiments have been focused on. Those of ordinary skill in the art to which the present disclosure pertains will be able to understand that the present disclosure can be implemented in a modified form within a range that does not depart from essential characteristics of the present disclosure. Therefore, the disclosed embodiments should be considered from an illustrative perspective rather than a restrictive perspective.

The scope of the present disclosure is shown in the claims rather than the foregoing description, and all differences within the equivalent scope should be interpreted as being included in the present disclosure.

Meanwhile, the above-described embodiments of the present disclosure can be written as a program that can be executed on a computer, and can be implemented in a general-purpose digital computer that operates a program using a computer-readable recording medium. Computer-readable recording media include storage media such as magnetic storage media (for example, ROM, floppy disk, hard disk, etc.) and optical reading media (for example, CD-ROM, DVD, etc.).

What is claimed is:

1. A radiation detector for detecting radiation, comprising:
a radiation detection panel, which is flexible, extending in a first direction and detecting radiation incident on a first surface;
a bending support unit coupled to the radiation detection panel and supporting the radiation detection panel, and controlling bending based on a bending axis parallel to a second direction of the radiation detection panel; and
a posture-position sensor coupled to the bending support unit, for determining at least one of a degree of bending of the radiation detection panel or a position of the radiation detection panel with respect to an object.

2. The radiation detector according to claim 1,
wherein the radiation detector comprises a controller for controlling an operation of the radiation detector, and
wherein the controller determines an initial position of the radiation detector with respect to the object based on the posture-position sensor, and
when the radiation detector moves from the initial position, acquires the position of the radiation detection panel with respect to the object in real time based on the posture-position sensor.

3. The radiation detector according to claim 1,
wherein the radiation detector comprises a controller for controlling an operation of the radiation detector,
wherein, when the second direction is parallel to a ground, the controller determines the position of the radiation detection panel with respect to the object using at least one of an acceleration sensor and a gyro sensor included in the posture-position sensor, and
wherein, when the second direction is perpendicular to the ground, the controller determines the position of the radiation detection panel with respect to the object using at least one of a geomagnetic sensor and a gyro sensor included in the posture-position sensor.

4. The radiation detector according to claim 1,
wherein the radiation detector comprises a controller for controlling an operation of the radiation detector, and
wherein the controller:
determines a first position included in the position of the radiation detection panel with respect to the object using at least one of an acceleration sensor and a gyro sensor included in the posture-position sensor; and
determines a second position included in the position of the radiation detection panel with respect to the object using at least one of a geomagnetic sensor and a gyro sensor included in the posture-position sensor.

5. The radiation detector according to claim 1,
wherein the radiation detector comprises a controller for controlling an operation of the radiation detector, and
wherein the controller acquires a degree of bending of the radiation detection panel with respect to a predetermined initial posture based on the posture-position sensor.

6. The radiation detector according to claim 1,
wherein the posture-position sensor comprises at least one of a potentiometer, a geomagnetic sensor, an acceleration sensor, and a gyro sensor.

7. The radiation detector according to claim 1,
wherein the bending support unit comprises:
a central rear cover; and
a side rear cover rotatable with respect to the central rear cover based on an axis parallel to the second direction,
wherein a potentiometer included in the posture-position sensor outputs a different potentiometer output value as the side rear cover rotates with respect to the central rear cover, and
wherein a controller determines the degree of bending of the radiation detection panel based on the potentiometer output value.

8. The radiation detector according to claim 1,
wherein the bending support unit comprises:
a central rear cover comprising a first posture-position sensor included in the posture-position sensor; and
a side rear cover rotatable with respect to the central rear cover based on an axis parallel to the second direction and comprising a second posture-position sensor included in the posture-position sensor, and
wherein at least one of a bending angle of the radiation detection panel or the position of the radiation detection panel with respect to the object is determined based on at least one of a first direction angle measured by the first posture-position sensor and a second direction angle measured by the second posture-position sensor.

9. The radiation detector according to claim 1,
wherein the bending support unit comprises:
a central rear cover;
a side rear cover rotatable with respect to the central rear cover based on an axis parallel to the second direction;
a sliding guide unit coupled to a rear of the side rear cover and comprising a potentiometer included in the posture-position sensor; and
a sliding unit having one side coupled to the central rear cover and another side coupled to the potentiometer, and slidably coupled to the sliding guide unit,
wherein, when the bending support unit is bent or unfolded, the sliding unit slides along the sliding guide unit,
wherein, when the sliding unit slides along the sliding guide unit, a potentiometer output value of the potentiometer is changed, and
wherein a controller determines the degree of bending of the radiation detection panel based on the potentiometer output value.

10. The radiation detector according to claim 1,
wherein the bending support unit comprises:
a central rear cover;
a side rear cover rotatable with respect to the central rear cover based on an axis parallel to the second direction;
a sliding guide unit coupled to a rear of the side rear cover and comprising a rack gear; and
a sliding unit having one side coupled to the central rear cover and another side coupled to a potentiometer included in the posture-position sensor, and slidably coupled to the sliding guide unit,
wherein, when the bending support unit is bent or unfolded, the sliding unit slides along the sliding guide unit,
wherein, when the sliding unit slides along the sliding guide unit, a potentiometer output value is changed as a pinion gear coupled to the potentiometer rotates by being engaged with the rack gear, and
wherein a controller determines the degree of bending of the radiation detection panel based on the potentiometer output value.

11. The radiation detector according to claim 1,
wherein the radiation detector comprises a controller for controlling an operation of the radiation detector,
wherein the controller determines a number of times of bending for each bending degree based on bending information of the radiation detection panel,
wherein the number of times of bending indicates a number of times the radiation detection panel is bent and then unfolded again, and
wherein the bending degree means a degree to which the radiation detection panel is maximally bent when one time of bending is performed.

12. The radiation detector according to claim 1,
wherein the radiation detector comprises a controller for controlling an operation of the radiation detector, and
wherein the controller determines that a force applied to bending is larger as the degree of bending of the radiation detection panel indicates more bending.

13. The radiation detector according to claim 12,
wherein the controller:
determines measured bending information related to a force required to bend the radiation detection panel;
determines bending correction information based on the degree of bending of the radiation detection panel; and
determines corrected bending information by adding the bending correction information to the measured bending information.

14. The radiation detector according to claim 13,
wherein the controller determines the bending correction information by multiplying a quotient, obtained by dividing the degree of bending of the radiation detection panel by a predetermined unit variation, by a predetermined bending weight.

15. The radiation detector according to claim 11,
wherein the controller:
acquires first usage information obtained by multiplying corrected bending information corresponding to a first bending degree by the number of times of bending corresponding to the first bending degree;
acquires second usage information obtained by multiplying the corrected bending information corresponding to a second bending degree by the number of times of bending corresponding to the second bending degree;
acquires total usage information obtained by adding the first usage information and the second usage information; and
when the total usage information is larger than predetermined lifespan information, outputs a message for performing a check on the detector.

16. The radiation detector according to claim 11,
wherein the controller acquires total usage information obtained by adding all the numbers of times of bending corresponding to the bending degree, and
when the total usage information is larger than predetermined lifespan information, outputs a message for performing a check on the detector.

17. The radiation detector according to claim 1,
wherein the radiation detector comprises a controller for controlling an operation of the radiation detector, and
wherein the controller determines whether or not to be in a power saving mode based on the degree of bending of the radiation detection panel.

18. The radiation detector according to claim 1,
wherein the radiation detector comprises a controller for controlling an operation of the radiation detector,
wherein the controller determines correction data based on the degree of bending of the radiation detection panel, and
wherein the correction data is data for correcting at least one of a magnitude of radiation and a reception direction of radiation received by a pixel of the radiation detection panel according to the degree of bending of the radiation detection panel.

19. The radiation detector according to claim 1,
wherein the radiation detector comprises a controller for controlling an operation of the radiation detector, and
wherein the controller determines whether or not an impact unintended by user has been applied based on a sensor value of the posture-position sensor.
